(19) United States
(12) Patent Application Publication
(10) Pub. No.: US 2023/0300829 A1
(43) Pub. Date: Sep. 21, 2023

(54) METHOD, USER EQUIPMENT, PROCESSING DEVICE, STORAGE MEDIUM, AND COMPUTER PROGRAM FOR TRANSMITTING PUSCH, AND METHOD AND BASE STATION FOR RECEIVING PUSCH

(71) Applicant: LG ELECTRONICS INC., Seoul (KR)

(72) Inventors: Duckhyun BAE, Seoul (KR); Suckchel YANG, Seoul (KR); Seonwook KIM, Seoul (KR); Sechang MYUNG, Seoul (KR)

(21) Appl. No.: 18/019,078

(22) PCT Filed: Aug. 6, 2021
(86) PCT No.: PCT/KR2021/010392

§ 371 Date: Jan. 31, 2023

(30) Foreign Application Priority Data
Aug. 6, 2020 (KR) 10-2020-0098854

(51) Int. Cl. H04W 72/1268; H04W 72/0446; H04L 5/14

(52) U.S. Cl. CPC H04W 72/1268; H04W 72/0446; H04L 5/1469

(57) ABSTRACT

UE may: receive resource allocation; determine a plurality of physical uplink shared channel (PUSCH) periods on the basis of the resource allocation; when a predetermined condition is satisfied, perform PUSCH transmission on a PUSCH period whose time length is less than or equal to a certain length from among the plurality of PUSCH periods; and when the predetermined condition is not satisfied, omit the PUSCH transmission.

### CROSS-REFERENCE TO RELATED APPLICATIONS

This application is the National Stage filing under 35 U.S.C. 371 of International Application No. PCT/KR2021/010392, filed on Aug. 6, 2021, which claims the benefit of earlier filing date and right of priority to Korean Patent Application No. 10-2020-0098854, filed on Aug. 6, 2020, the contents of which are all incorporated by reference herein in their entirety.

### TECHNICAL FIELD

The present disclosure relates to a wireless communication system.

### BACKGROUND

A variety of technologies, such as machine-to-machine (M2M) communication, machine type communication (MTC), and a variety of devices demanding high data throughput, such as smartphones and tablet personal computers (PCs), have emerged and spread. Accordingly, the volume of data throughput demanded to be processed in a cellular network has rapidly increased. In order to satisfy such rapidly increasing data throughput, carrier aggregation technology or cognitive radio technology for efficiently employing more frequency bands and multiple input multiple output (MIMO) technology or multi-base station (BS) cooperation technology for raising data capacity transmitted on limited frequency resources have been developed.

As more and more communication devices have required greater communication capacity, there has been a need for enhanced mobile broadband (eMBB) communication relative to legacy radio access technology (RAT). In addition, massive machine type communication (mMTC) for providing various services at anytime and anywhere by connecting a plurality of devices and objects to each other is one main issue to be considered in next-generation communication.

Communication system design considering services/user equipment (UEs) sensitive to reliability and latency is also under discussion. The introduction of next-generation RAT is being discussed in consideration of eMBB communication, mMTC, ultra-reliable and low-latency communication (URLLC), and the like.

### SUMMARY

As new radio communication technology has been introduced, the number of UEs to which a BS should provide services in a prescribed resource region is increasing and the volume of data and control information that the BS transmits/receives to/from the UEs to which the BS provides services is also increasing. Since the amount of resources available to the BS for communication with the UE(s) is limited, a new method for the BS to efficiently receive/transmit uplink/downlink data and/or uplink/downlink control information from/to the UE(s) using the limited radio resources is needed. In other words, due to increase in the density of nodes and/or the density of UEs, a method for efficiently using high-density nodes or high-density UEs for communication is needed.

A method to efficiently support various services with different requirements in a wireless communication system is also needed.

Overcoming delay or latency is an important challenge to applications, performance of which is sensitive to delay/latency.

The objects to be achieved with the present disclosure are not limited to what has been particularly described hereinabove and other objects not described herein will be more clearly understood by persons skilled in the art from the following detailed description.

According to an aspect of the present disclosure, a method of transmitting a physical uplink shared channel (PUSCH) by a user equipment (UE) in a wireless communication system is provided. The method includes receiving resource allocation, determining a plurality of PUSCH occasions based on the resource allocation, and for a PUSCH occasion having a time length equal to or less than a predetermined length among the plurality of PUSCH occasions, performing PUSCH transmission if a predetermined condition is satisfied, and omitting the PUSCH transmission if the predetermined condition is not satisfied.

According to another aspect of the present disclosure, a user equipment for transmitting a physical uplink shared channel (PUSCH) in a wireless communication system is provided. The UE includes at least one transceiver, at least one processor, and at least one computer memory operatively connected to the at least one processor and configured to store instructions that when executed causes the at least one processor to perform operations. The operations include receiving resource allocation, determining a plurality of PUSCH occasions based on the resource allocation, and for a PUSCH occasion having a time length equal to or less than a predetermined length among the plurality of PUSCH occasions, performing PUSCH transmission if a predetermined condition is satisfied, and omitting the PUSCH transmission if the predetermined condition is not satisfied.

According to another aspect of the present disclosure, a processing device in a wireless communication system is provided. The processing device includes at least one processor, and at least one computer memory operatively connected to the at least one processor and configured to store instructions that when executed causes the at least one processor to perform operations. The operations include receiving resource allocation, determining a plurality of PUSCH occasions based on the resource allocation, and for a PUSCH occasion having a time length equal to or less than a predetermined length among the plurality of PUSCH occasions, performing PUSCH transmission if a predetermined condition is satisfied, and omitting the PUSCH transmission if the predetermined condition is not satisfied.

According to another aspect of the present disclosure, a computer-readable storage medium is provided. The computer-readable storage medium stores at least one computer program including at least one instruction for causing at least one processor to perform operations for a user equipment (UE) when being executed by the at least one processor. The operations include receiving resource allocation, determining a plurality of PUSCH occasions based on the resource allocation, and for a PUSCH occasion having a time length equal to or less than a predetermined length among the plurality of PUSCH occasions, performing PUSCH transmission if a predetermined condition is satisfied, and omitting the PUSCH transmission if the predetermined condition is not satisfied.

According to another aspect of the present disclosure, a computer program stored in a computer-readable storage medium is provided. The computer program includes at least one program code including instructions for causing at least one processor to perform operations when being executed, and the operations include receiving resource allocation, determining a plurality of PUSCH occasions based on the resource allocation, and for a PUSCH occasion having a time length equal to or less than a predetermined length among the plurality of PUSCH occasions, performing PUSCH transmission if a predetermined condition is satisfied, and omitting the PUSCH transmission if the predetermined condition is not satisfied.

According to another aspect of the present disclosure, a method of receiving a physical uplink shared channel (PUSCH) from a user equipment (UE) by a base station (BS) in a wireless communication system is provided. The method includes transmitting resource allocation to the UE, determining a plurality of physical uplink shared channel (PUSCH) occasions based on the resource allocation, and for a PUSCH occasion having a time length equal to or less than a predetermined length among the plurality of PUSCH occasions, performing PUSCH reception if a predetermined condition is satisfied, and omitting the PUSCH reception if the predetermined condition is not satisfied.

According to another aspect of the present disclosure, a base station (BS) for receiving a physical uplink shared channel (PUSCH) from a user equipment (UE) in a wireless communication system is provided. The BS includes at least one transceiver, at least one processor, and at least one computer memory operatively connected to the at least one processor and configured to store instructions that when executed causes the at least one processor to perform operations. The operations include transmitting resource allocation to the UE, determining a plurality of physical uplink shared channel (PUSCH) occasions based on the resource allocation, and for a PUSCH occasion having a time length equal to or less than a predetermined length among the plurality of PUSCH occasions, performing PUSCH reception if a predetermined condition is satisfied, and omitting the PUSCH reception if the predetermined condition is not satisfied.

According to each aspect of the present disclosure, the predetermined condition may include a following condition: an immediately next symbol of a last symbol of the PUSCH occasion for which a time length is equal to or less than the predetermined length is a start symbol of another PUSCH occasion.

According to each aspect of the present disclosure, the predetermined condition includes a following condition: an immediately next symbol of a last symbol of the PUSCH occasion for which a time length is equal to or less than the predetermined length is configured as an uplink symbol through a radio resource control configuration for a time division duplex (TDD) uplink-downlink configuration.

According to each aspect of the present disclosure, the resource allocation includes i) a number of resources repeated in consecutive symbols, ii) a number of slots in which consecutive resources are repeated, and iii) a number of resources used for one transport block.

The foregoing solutions are merely a part of the examples of the present disclosure and various examples into which the technical features of the present disclosure are incorporated may be derived and understood by persons skilled in the art from the following detailed description.

According to implementation(s) of the present disclosure, a wireless communication signal may be efficiently transmitted/received. Accordingly, the total throughput of a wireless communication system may be raised.

According to implementation(s) of the present disclosure, various services with different requirements may be efficiently supported in a wireless communication system.

According to implementation(s) of the present disclosure, delay/latency generated during radio communication between communication devices may be reduced.

The effects according to the present disclosure are not limited to what has been particularly described hereinabove and other effects not described herein will be more clearly understood by persons skilled in the art related to the present disclosure from the following

### BRIEF DESCRIPTION OF DRAWINGS

The accompanying drawings, which are included to provide a further understanding of the present disclosure, illustrate examples of implementations of the present disclosure and together with the detailed description serve to explain implementations of the present disclosure:

FIG. 1 illustrates an example of a communication system 1 to which implementations of the present disclosure are applied;

FIG. 2 is a block diagram illustrating examples of communication devices capable of performing a method according to the present disclosure;

FIG. 3 illustrates another example of a wireless device capable of performing implementation(s) of the present disclosure;

FIG. 4 illustrates an example of a frame structure used in a 3rd generation partnership project (3GPP)-based wireless communication system;

FIG. 5 illustrates a resource grid of a slot;

FIG. 6 illustrates slot structures available in a 3GPP based system;

FIG. 7 illustrates an example of physical downlink shared channel (PDSCH) time domain resource allocation (TDRA) caused by a physical downlink control channel (PDCCH) and an example of physical uplink shared channel (PUSCH) TDRA caused by the PDCCH;

FIG. 8 illustrates a hybrid automatic repeat request-acknowledgement (HARQ-ACK) transmission/reception procedure;

FIG. 9 illustrates types of repeated transmissions;

FIG. 10 shows an example of a channel transmission flow in a UE according to some implementations of the present disclosure;

FIGS. 11 to 14 show examples of resource allocations for repeated transmissions according to some implementations of the present disclosure;

FIG. 15 shows an example of a channel reception flow in a BS according to some implementations of the present disclosure; and

FIG. 16 illustrates a downlink channel transmission flow according to some implementations of the present disclosure.

### DETAILED DESCRIPTION

Hereinafter, implementations according to the present disclosure will be described in detail with reference to the accompanying drawings. The detailed description, which will be given below with reference to the accompanying drawings, is intended to explain exemplary implementations of the present disclosure, rather than to show the only implementations that may be implemented according to the present disclosure. The following detailed description includes specific details in order to provide a thorough understanding of the present disclosure. However, it will be apparent to those skilled in the art that the present disclosure may be practiced without such specific details.

In some instances, known structures and devices may be omitted or may be shown in block diagram form, focusing on important features of the structures and devices, so as not to obscure the concept of the present disclosure. The same reference numbers will be used throughout the present disclosure to refer to the same or like parts.

A technique, a device, and a system described below may be applied to a variety of wireless multiple access systems. The multiple access systems may include, for example, a code division multiple access (CDMA) system, a frequency division multiple access (FDMA) system, a time division multiple access (TDMA) system, an orthogonal frequency division multiple access (OFDMA) system, a single-carrier frequency division multiple access (SC-FDMA) system, a multi-carrier frequency division multiple access (MC-FDMA) system, etc. CDMA may be implemented by radio technology such as universal terrestrial radio access (UTRA) or CDMA2000. TDMA may be implemented by radio technology such as global system for mobile communications (GSM), general packet radio service (GPRS), enhanced data rates for GSM evolution (EDGE) (i.e., GERAN), etc. OFDMA may be implemented by radio technology such as institute of electrical and electronics engineers (IEEE) 802.11 (Wi-Fi), IEEE 802.16 (WiMAX), IEEE 802.20, evolved-UTRA (E-UTRA), etc. UTRA is part of universal mobile telecommunications system (UMTS) and 3rd generation partnership project (3GPP) long-term evolution (LTE) is part of E-UMTS using E-UTRA. 3GPP LTE adopts OFDMA on downlink (DL) and adopts SC-FDMA on uplink (UL). LTE-advanced (LTE-A) is an evolved version of 3GPP LTE.

For convenience of description, description will be given under the assumption that the present disclosure is applied to LTE and/or new RAT (NR). However, the technical features of the present disclosure are not limited thereto. For example, although the following detailed description is given based on mobile communication systems corresponding to 3GPP LTE/NR systems, the mobile communication systems are applicable to other arbitrary mobile communication systems except for matters that are specific to the 3GPP LTE/NR system.

For terms and techniques that are not described in detail among terms and techniques used in the present disclosure, reference may be made to 3GPP based standard specifications, for example, 3GPP TS 36.211, 3GPP TS 36.212, 3GPP TS 36.213, 3GPP TS 36.321, 3GPP TS 36.300, 3GPP TS 36.331, 3GPP TS 37.213, 3GPP TS 38.211, 3GPP TS 38.212, 3GPP TS 38.213, 3GPP TS 38.214, 3GPP TS 38.300, and 3GPP TS 38.331, etc.

In examples of the present disclosure described later, if a device “assumes” something, this may mean that a channel transmission entity transmits a channel in compliance with the corresponding “assumption”. This also may mean that a channel reception entity receives or decodes the channel in the form of conforming to the “assumption” on the premise that the channel has been transmitted in compliance with the “assumption”.

In the present disclosure, a user equipment (UE) may be fixed or mobile. Each of various devices that transmit and/or receive user data and/or control information by communicating with a base station (BS) may be the UE. The term UE may be referred to as terminal equipment, mobile station (MS), mobile terminal (MT), user terminal (UT), subscriber station (SS), wireless device, personal digital assistant (PDA), wireless modem, handheld device, etc. In the present disclosure, a BS refers to a fixed station that communicates with a UE and/or another BS and exchanges data and control information with a UE and another BS. The term BS may be referred to as advanced base station (ABS), Node-B (NB), evolved Node-B (eNB), base transceiver system (BTS), access point (AP), processing server (PS), etc. Particularly, a BS of a universal terrestrial radio access (UTRAN) is referred to as an NB, a BS of an evolved-UTRAN (E-UTRAN) is referred to as an eNB, and a BS of new radio access technology network is referred to as a gNB. Hereinbelow, for convenience of description, the NB, eNB, or gNB will be referred to as a BS regardless of the type or version of communication technology.

In the present disclosure, a node refers to a fixed point capable of transmitting/receiving a radio signal to/from a UE by communication with the UE. Various types of BSs may be used as nodes regardless of the names thereof. For example, a BS, NB, eNB, pico-cell eNB (PeNB), home eNB (HeNB), relay, repeater, etc. may be a node. Furthermore, a node may not be a BS. For example, a radio remote head (RRH) or a radio remote unit (RRU) may be a node. Generally, the RRH and RRU have power levels lower than that of the BS. Since the RRH or RRU (hereinafter, RRH/RRU) is connected to the BS through a dedicated line such as an optical cable in general, cooperative communication according to the RRH/RRU and the BS may be smoothly performed relative to cooperative communication according to BSs connected through a wireless link. At least one antenna is installed per node. An antenna may refer to a physical antenna port or refer to a virtual antenna or an antenna group. The node may also be called a point.

In the present disclosure, a cell refers to a specific geographical area in which one or more nodes provide communication services. Accordingly, in the present disclosure, communication with a specific cell may mean communication with a BS or a node providing communication services to the specific cell. A DL/UL signal of the specific cell refers to a DL/UL signal from/to the BS or the node providing communication services to the specific cell. A cell providing UL/DL communication services to a UE is especially called a serving cell. Furthermore, channel status/quality of the specific cell refers to channel status/quality of a channel or a communication link generated between the BS or the node providing communication services to the specific cell and the UE. In 3GPP-based communication systems, the UE may measure a DL channel state from a specific node using cell-specific reference signal(s) (CRS(s)) transmitted on a CRS resource and/or channel state information reference signal(s) (CSI-RS(s)) transmitted on a CSI-RS resource, allocated to the specific node by antenna port(s) of the specific node.

A 3GPP-based communication system uses the concept of a cell in order to manage radio resources, and a cell related to the radio resources is distinguished from a cell of a geographic area.

The “cell” of the geographic area may be understood as coverage within which a node may provide services using a carrier, and the “cell” of the radio resources is associated with bandwidth (BW), which is a frequency range configured by the carrier. Since DL coverage, which is a range within which the node is capable of transmitting a valid signal, and UL coverage, which is a range within which the node is capable of receiving the valid signal from the UE, depend upon a carrier carrying the signal, coverage of the node may also be associated with coverage of the “cell” of radio resources used by the node. Accordingly, the term “cell” may be used to indicate service coverage by the node sometimes, radio resources at other times, or a range that a signal using the radio resources may reach with valid strength at other times.

In 3GPP communication standards, the concept of the cell is used in order to manage radio resources. The “cell” associated with the radio resources is defined by a combination of DL resources and UL resources, that is, a combination of a DL component carrier (CC) and a UL CC. The cell may be configured by the DL resources only or by the combination of the DL resources and the UL resources. If carrier aggregation is supported, linkage between a carrier frequency of the DL resources (or DL CC) and a carrier frequency of the UL resources (or UL CC) may be indicated by system information. For example, the combination of the DL resources and the UL resources may be indicated by system information block type 2 (SIB2) linkage. In this case, the carrier frequency may be equal to or different from a center frequency of each cell or CC. When carrier aggregation (CA) is configured, the UE has only one radio resource control (RRC) connection with a network. During RRC connection establishment/re-establishment/handover, one serving cell provides non-access stratum (NAS) mobility information. During RRC connection re-establishment/handover, one serving cell provides security input. This cell is referred to as a primary cell (Pcell). The Pcell refers to a cell operating on a primary frequency on which the UE performs an initial connection establishment procedure or initiates a connection re-establishment procedure. According to UE capability, secondary cells (Scells) may be configured to form a set of serving cells together with the Pcell. The S cell may be configured after completion of RRC connection establishment and used to provide additional radio resources in addition to resources of a specific cell (SpCell). A carrier corresponding to the Pcell on DL is referred to as a downlink primary CC (DL PCC), and a carrier corresponding to the Pcell on UL is referred to as an uplink primary CC (UL PCC). A carrier corresponding to the S cell on DL is referred to as a downlink secondary CC (DL SCC), and a carrier corresponding to the Scell on UL is referred to as an uplink secondary CC (UL SCC).

For dual connectivity (DC) operation, the term SpCell refers to the Pcell of a master cell group (MCG) or the Pcell of a secondary cell group (SCG). The SpCell supports PUCCH transmission and contention-based random access and is always activated. The MCG is a group of service cells associated with a master node (e.g., BS) and includes the SpCell (Pcell) and optionally one or more Scells. For a UE configured with DC, the SCG is a subset of serving cells associated with a secondary node and includes a PSCell and 0 or more Scells. For a UE in RRC_CONNECTED state, not configured with CA or DC, only one serving cell including only the Pcell is present. For a UE in RRC_CONNECTED state, configured with CA or DC, the term serving cells refers to a set of cells including SpCell(s) and all Scell(s). In DC, two medium access control (MAC) entities, i.e., one MAC entity for the MCG and one MAC entity for the SCG, are configured for the UE.

A UE with which CA is configured and DC is not configured may be configured with a Pcell PUCCH group, which includes the Pcell and 0 or more Scells, and an Scell PUCCH group, which includes only Scell(s). For the Scells, an Scell on which a PUCCH associated with the corresponding cell is transmitted (hereinafter, PUCCH cell) may be configured. An Scell indicated as the PUCCH Scell belongs to the Scell PUCCH group and PUCCH transmission of related uplink control information (UCI) is performed on the PUCCH Scell. An Scell, which is not indicated as the PUCCH Scell or in which a cell indicated for PUCCH transmission is a Pcell, belongs to the Pcell PUCCH group and PUCCH transmission of related UCI is performed on the Pcell.

In a wireless communication system, the UE receives information on DL from the BS and the UE transmits information on UL to the BS. The information that the BS and UE transmit and/or receive includes data and a variety of control information and there are various physical channels according to types/usage of the information that the UE and the BS transmit and/or receive.

The 3GPP-based communication standards define DL physical channels corresponding to resource elements carrying information originating from a higher layer and DL physical signals corresponding to resource elements which are used by the physical layer but do not carry the information originating from the higher layer. For example, a physical downlink shared channel (PDSCH), a physical broadcast channel (PBCH), a physical multicast channel (PMCH), a physical control format indicator channel (PCFICH), a physical downlink control channel (PDCCH), etc. are defined as the DL physical channels, and a reference signal (RS) and a synchronization signal (SS) are defined as the DL physical signals. The RS, which is also referred to as a pilot, represents a signal with a predefined special waveform known to both the BS and the UE. For example, a demodulation reference signal (DMRS), a channel state information RS (CSI-RS), etc. are defined as DL RSs. The 3GPP-based communication standards define UL physical channels corresponding to resource elements carrying information originating from the higher layer and UL physical signals corresponding to resource elements which are used by the physical layer but do not carry the information originating from the higher layer. For example, a physical uplink shared channel (PUSCH), a physical uplink control channel (PUCCH), and a physical random access channel (PRACH) are defined as the UL physical channels, and a DMRS for a UL control/data signal, a sounding reference signal (SRS) used for UL channel measurement, etc. are defined.

In the present disclosure, the PDCCH refers to a set of time-frequency resources (e.g., resource elements (REs)) that is a set of REs that carry downlink control information (DCI), and the PDSCH refers to a set of time-frequency resources that is a set of REs that carry DL data. The PUCCH, PUSCH, and PRACH refer to a set of time-frequency resources that is a set of time-frequency REs that carry uplink control information (UCI), UL data, and random access signals, respectively. In the following description, the meaning of “The UE transmits/receives the PUCCH/PUSCH/PRACH” is that the UE transmits/receives the UCI/UL data/random access signals on or through the PUCCH/PUSCH/PRACH, respectively. In addition, the meaning of “the BS transmits/receives the PBCH/PDCCH/PDSCH” is that the BS transmits the broadcast information/DCI/DL data on or through a PBCH/PDCCH/PDSCH, respectively.

In the present disclosure, a radio resource (e.g., a time-frequency resource) scheduled or configured to the UE by the BS for transmission or reception of the PUCCH/PUSCH/PDSCH may be referred to as a PUCCH/PUSCH/PDSCH resource.

Since a communication device receives an SS/PBCH resource block (SSB), DMRS, CSI-RS, PBCH, PDCCH, PDSCH, PUSCH, and/or PUCCH in the form of radio signals on a cell, the communication device may not select and receive radio signals including only a specific physical channel or a specific physical signal through a radio frequency (RF) receiver or select and receive radio signals without a specific physical channel or a specific physical signal through the RF receiver. In actual operations, the communication device receives radio signals on the cell via the RF receiver, converts the radio signals, which are RF band signals, into baseband signals, and then decodes physical signals and/or physical channels in the baseband signals using one or more processors. Thus, in some implementations of the present disclosure, not receiving physical signals and/or physical channels may mean that a communication device does not attempt to restore the physical signals and/or physical channels from radio signals, for example, does not attempt to decode the physical signals and/or physical channels, rather than that the communication device does not actually receive the radio signals including the corresponding physical signals and/or physical channels.

As more and more communication devices have required greater communication capacity, there has been a need for eMBB communication relative to legacy radio access technology (RAT). In addition, massive MTC for providing various services at anytime and anywhere by connecting a plurality of devices and objects to each other is one main issue to be considered in next-generation communication. Further, communication system design considering services/UEs sensitive to reliability and latency is also under discussion. The introduction of next-generation RAT is being discussed in consideration of eMBB communication, massive MTC, ultra-reliable and low-latency communication (URLLC), and the like. Currently, in 3GPP, a study on the next-generation mobile communication systems after EPC is being conducted. In the present disclosure, for convenience, the corresponding technology is referred to as a new RAT (NR) or fifth-generation (5G) RAT, and a system using NR or supporting NR is referred to as an NR system.

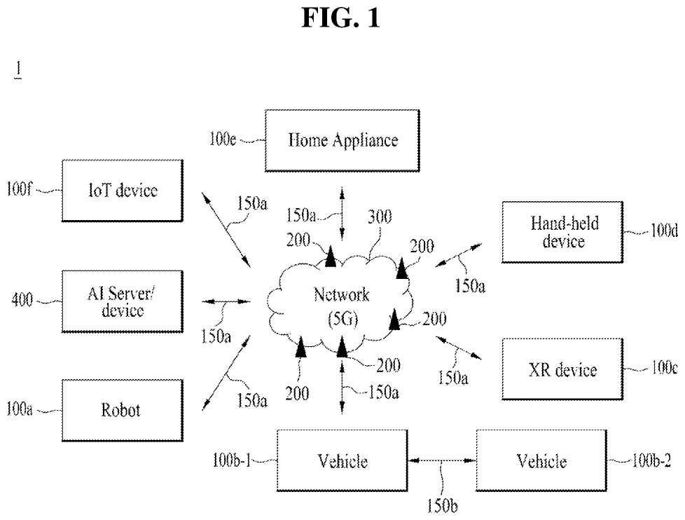

FIG. 1 illustrates an example of a communication system 1 to which implementations of the present disclosure are applied. Referring to FIG. 1, the communication system 1 applied to the present disclosure includes wireless devices, BSs, and a network. Here, the wireless devices represent devices performing communication using RAT (e.g., 5G NR or LTE (e.g., E-UTRA)) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 400. For example, the vehicles may include a vehicle having a wireless communication function, an autonomous driving vehicle, and a vehicle capable of performing vehicle-to-vehicle communication. Here, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or smartglasses), and a computer (e.g., a notebook). The home appliance may include a TV, a refrigerator, and a washing machine. The IoT device may include a sensor and a smartmeter. For example, the BSs and the network may also be implemented as wireless devices and a specific wireless device may operate as a BS/network node with respect to another wireless device.

The wireless devices 100a to 100f may be connected to a network 300 via BSs 200. AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. vehicle-to-vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a and 150b may be established between the wireless devices 100a to 100f and the BSs 200 and between the wireless devices 100a to 100f). Here, the wireless communication/connections such as UL/DL communication 150a and sidelink communication 150b (or, device-to-device (D2D) communication) may be established by various RATs (e.g., 5G NR). The wireless devices and the BSs/wireless devices may transmit/receive radio signals to/from each other through the wireless communication/connections 150a and 150b. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

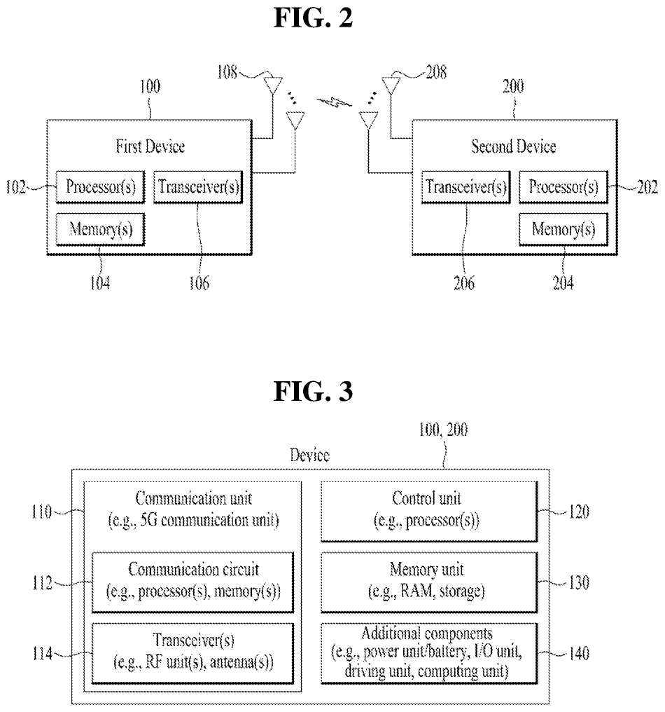

FIG. 2 is a block diagram illustrating examples of communication devices capable of performing a method according to the present disclosure. Referring to FIG. 2, a first wireless device 100 and a second wireless device 200 may transmit and/or receive radio signals through a variety of RATs (e.g., LTE and NR). Here, {the first wireless device 100 and the second wireless device 200} may correspond to {the wireless device 100x and the BS 200} and/or {the wireless device 100x and the wireless device 100x} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the after-described/proposed functions, procedures, and/or methods. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may perform a part or all of processes controlled by the processor(s) 102 or store software code including instructions for performing the after-described/proposed procedures and/or methods. Here, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 is used interchangeably with radio frequency (RF) unit(s). In the present disclosure, the wireless device may represent the communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the after-described/proposed functions, procedures, and/or methods. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may perform a part or all of processes controlled by the processor(s) 202 or store software code including instructions for performing the after-described/proposed procedures and/or methods. Here, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 is used interchangeably with RF unit(s). In the present disclosure, the wireless device may represent the communication modem/circuit/chip.

The wireless communication technology implemented in the wireless devices 100 and 200 of the present disclosure may include narrowband Internet of things for low-power communication as well as LTE, NR, and 6G. For example, the NB-IoT technology may be an example of low-power wide-area network (LPWAN) technologies and implemented in standards such as LTE Cat NB1 and/or LTE Cat NB2. However, the NB-IoT technology is not limited to the above names. Additionally or alternatively, the wireless communication technology implemented in the wireless devices XXX and YYY of the present disclosure may perform communication based on the LTE-M technology. For example, the LTE-M technology may be an example of LPWAN technologies and called by various names including enhanced machine type communication (eMTC). For example, the LTE-M technology may be implemented in at least one of the following various standards: 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, etc., but the LTE-M technology is not limited to the above names Additionally or alternatively, the wireless communication technology implemented in the wireless devices XXX and YYY of the present disclosure may include at least one of ZigBee, Bluetooth, and LPWAN in consideration of low-power communication, but the wireless communication technology is not limited to the above names. For example, the ZigBee technology may create a personal area network (PAN) related to small/low-power digital communication based on various standards such as IEEE 802.15.4 and so on, and the ZigBee technology may be called by various names.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as a physical (PHY) layer, medium access control (MAC) layer, a radio link control (RLC) layer, a packet data convergence protocol (PDCP) layer, radio resource control (RRC) layer, and a service data adaptation protocol (SDAP) layer). The one or more processors 102 and 202 may generate one or more protocol data units (PDUs) and/or one or more service data units (SDUs) according to the functions, procedures, proposals, and/or methods disclosed in this document. The one or more processors 102 and 202 may generate messages, control information, data, or information according to the functions, procedures, proposals, and/or methods disclosed in this document. The one or more processors 102 and 202 may generate signals (e.g., baseband signals) including PDUs, SDUs, messages, control information, data, or information according to the functions, procedures, proposals, and/or methods disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals, and/or methods disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The functions, procedures, proposals, and/or methods disclosed in this document may be implemented using firmware or software, and the firmware or software may be configured to include the modules, procedures, or functions. Firmware or software configured to perform the functions, procedures, proposals, and/or methods disclosed in this document may be included in the one or more processors 102 and 202 or stored in the one or more memories 104 and 204 so as to be driven by the one or more processors 102 and 202. The functions, procedures, proposals, and/or methods disclosed in this document may be implemented using firmware or software in the form of code, commands, and/or a set of commands

The one or more memories 104 and 204 may be connected to the one or more processors 102 and 202 and store various types of data, signals, messages, information, programs, code, commands, and/or instructions. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208. The one or more transceivers 106 and 206 may be configured to transmit and receive user data, control information, and/or radio signals/channels, mentioned in the functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 3 illustrates another example of a wireless device capable of performing implementation(s) of the present disclosure. Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 2. For example, the transceiver(s) 114 may include the one or more transceivers 106 and 206 and/or the one or more antennas 108 and 208 of FIG. 2. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast UE, a hologram device, a public safety device, an MTC device, a medicine device, a fintech device (or a finance device), a security device, a climate/environment device, the AI server/device (400 of FIG. 1), the BS (200 of FIG. 1), a network node, etc. The wireless device may be used in a mobile or fixed place according to a use-case/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a random access memory (RAM), a dynamic RAM (DRAM), a read-only memory (ROM)), a flash memory, a volatile memory, a non-volatile memory, and/or a combination thereof.

In the present disclosure, at least one memory (e.g., 104 or 204) may store instructions or programs which, when executed, cause at least one processor operably coupled to the at least one memory to perform operations according to some embodiments or implementations of the present disclosure.

In the present disclosure, a computer-readable (non-transitory) storage medium may store at least one instruction or computer program which, when executed by at least one processor, causes the at least one processor to perform operations according to some embodiments or implementations of the present disclosure.

In the present disclosure, a processing device or apparatus may include at least one processor and at least one computer memory coupled to the at least one memory. The at least one computer memory may store instructions or programs which, when executed, cause the at least one processor operably coupled to the at least one memory to perform operations according to some embodiments or implementations of the present disclosure.

In the present disclosure, a computer program may include a program code stored on at least one computer-readable (non-volatile) storage medium and, when executed, configured to perform operations according to some implementations of the present disclosure or cause at least one processor to perform the operations according to some implementations of the present disclosure. The computer program may be provided in the form of a computer program product. The computer program product may include at least one computer-readable (non-volatile) storage medium.

A communication device of the present disclosure includes at least one processor; and at least one computer memory operably connectable to the at least one processor and configured to store instructions for causing, when executed, the at least one processor to perform

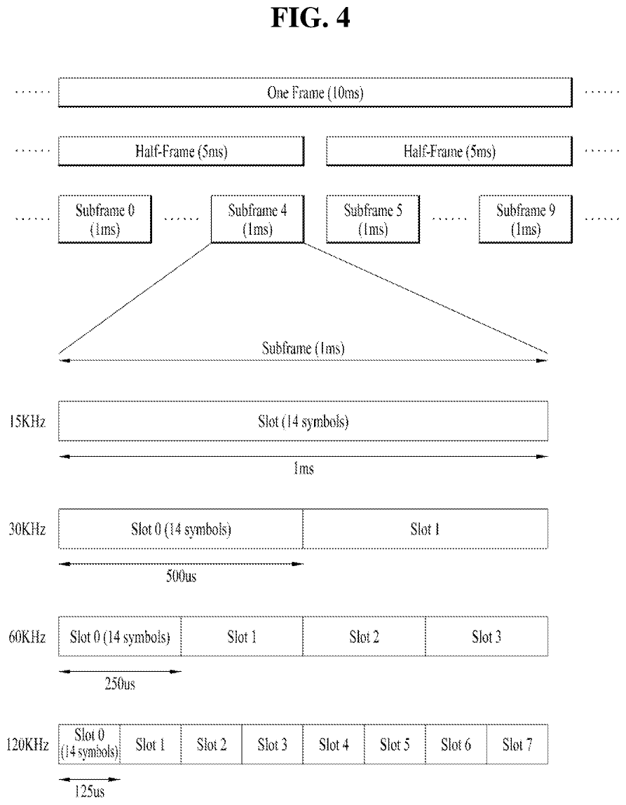

FIG. 4 illustrates an example of a frame structure used in a 3GPP-based wireless communication system.

The frame structure of FIG. 4 is purely exemplary and the number of subframes, the number of slots, and the number of symbols, in a frame, may be variously changed. In an NR system, different OFDM numerologies (e.g., subcarrier spacings (SCSs)) may be configured for multiple cells which are aggregated for one UE. Accordingly, the (absolute time) duration of a time resource including the same number of symbols (e.g., a subframe, a slot, or a transmission time interval (TTI)) may be differently configured for the aggregated cells. Here, the symbol may include an OFDM symbol (or cyclic prefix-OFDM (CP-OFDM) symbol) and an SC-FDMA symbol (or discrete Fourier transform-spread-OFDM (DFT-s-OFDM) symbol). In the present disclosure, the symbol, the OFDM-based symbol, the OFDM symbol, the CP-OFDM symbol, and the DFT-s-OFDM symbol are used interchangeably.

Rerferring to FIG. 4, in the NR system, UL and DL transmissions are organized into frames. Each half-frame includes 5 subframes and a duration Ts(of a single subframe is 1 ms. Subframes are further divided into slots and the number of slots in a subframe depends on a subcarrier spacing. Each slot includes 14 or 12 OFDM symbols based on a cyclic prefix. In a normal CP, each slot includes 14 OFDM symbols and, in an extended CP, each slot includes 12 OFDM symbols. The numerology depends on an exponentially scalable subcarrier spacing Δf=2^{u}*15 kHz. The table below shows the number of OFDM symbols (N^{slot}_{symb}) per slot, the number of slots (N^{frame,u}ₛₗₒₜ) per frame, and the number of slots (N^{subframe,u}ₛₗₒₜ) per subframe.

TABLE 1

| u | N^{slot}_{symb} | A^{frame,u}ₛₗₒₜ | N^{subframe,u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The table below shows the number of OFDM symbols per slot, the number of slots per frame, and the number of slots per subframe, according to the subcarrier spacing Δf=2^{u}*15 kHz.

TABLE 2

| u | N^{slot}_{symb} | A^{frame,u}ₛₗₒₜ | N^{subframe,u}ₛₗₒₜ |
|---|---|---|---|
| 2 | 12 | 40 | 4 |

For a search space configuration u, slots may be indexed within a subframe in ascending order as follows: n^{s}ᵤ∈{0, . . . , n^{subframe,u}ₛₗₒₜ−1} and indexed within a frame in ascending order as follows: n^{s,f}ᵤ∈{0, . . . , n^{frame,u}ₛₗₒₜ−1}.

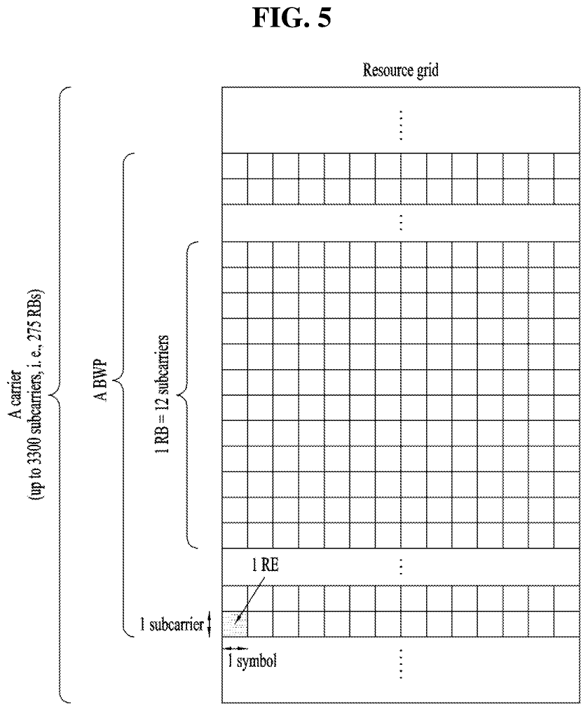

FIG. 5 illustrates a resource grid of a slot. The slot includes multiple (e.g., 14 or 12) symbols in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at a common resource block (CRB) N^{start,u}_{grid} indicated by higher layer signaling (e.g. RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP-based wireless communication system, N^{RB}_{sc} is typically 12. There is one resource grid for a given antenna port p, a subcarrier spacing configuration u, and a transmission link (DL or UL). The carrier bandwidth N^{size,i}_{grid} for the subcarrier spacing configuration u is given to the UE by a higher layer parameter (e.g. RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the NR system, an RB is defined by 12 consecutive subcarriers in the frequency domain. In the NR system, RBs are classified into CRBs and physical resource blocks (PRBs). The CRBs are numbered from 0 upwards in the frequency domain for the subcarrier spacing configuration u. The center of subcarrier 0 of CRB 0 for the subcarrier spacing configuration u is equal to ‘Point A’ which serves as a common reference point for RB grids. The PRBs for subcarrier spacing configuration u are defined within a bandwidth part (BWP) and numbered from 0 to N^{size,u}_{BWP,i}−1, where i is a number of the BWP. The relation between a PRB n_{PRB} in a BWP i and a CRB n^{u}_{CRB} is given by: n^{u}_{PRB}=n^{u}_{CRB}+N_{size,u}_{BWP,i} where N_{size}_{BWP,i} is a CRB in which the BWP starts relative to CRB 0. The BWP includes a plurality of consecutive RBs in the frequency domain. For example, the BWP may be a subset of contiguous CRBs defined for a given numerology uᵢ in the BWP i on a given carrier. A carrier may include a maximum of N (e.g., 5) BWPs. The UE may be configured to have one or more BWPs on a given component carrier. Data communication is performed through an activated BWP and only a predetermined number of BWPs (e.g., one BWP) among BWPs configured for the UE may be active on the component carrier.

For each serving cell in a set of DL BWPs or UL BWPs, the network may configure at least an initial DL BWP and one (if the serving cell is configured with uplink) or two (if supplementary uplink is used) initial UL BWPs. The network may configure additional UL and DL BWPs. For each DL BWP or UL BWP, the UE may be provided the following parameters for the serving cell: i) an SCS; ii) a CP; iii) a CRB N^{start}_{BWP}=O_{carrier}+RBₛₜₐᵣₜ and the number of contiguous RBs N^{size}_{BWP}=L_{RB} provided by an RRC parameter locationAndBandwidth, which indicates an offset RBₛₑₜ and a length L_{RB} as a resource indicator value (RIV) on the assumption of N^{start}_{BWP}=275, and a value O_{carrier} provided by an RRC parameter offsetToCarrier for the SCS; an index in the set of DL BWPs or UL BWPs; a set of BWP-common parameters; and a set of BWP-dedicated parameters.

Virtual resource blocks (VRBs) may be defined within the BWP and indexed from 0 to N^{size,u}_{BWP,i}−1, where i denotes a BWP number. The VRBs may be mapped to PRBs according to non-interleaved mapping. In some implementations, VRB n may be mapped to PRB n for non-interleaved VRB-to-PRB mapping.

The UE for which carrier aggregation is configured may be configured to use one or more cells. If the UE is configured with a plurality of serving cells, the UE may be configured with one or multiple cell groups. The UE may also be configured with a plurality of cell groups associated with different BSs. Alternatively, the UE may be configured with a plurality of cell groups associated with a single BS. Each cell group of the UE includes one or more serving cells and includes a single PUCCH cell for which PUCCH resources are configured. The PUCCH cell may be a Pcell or an Scell configured as the PUCCH cell among Scells of a corresponding cell group. Each serving cell of the UE belongs to one of cell groups of the UE and does not belong to a plurality of cells.

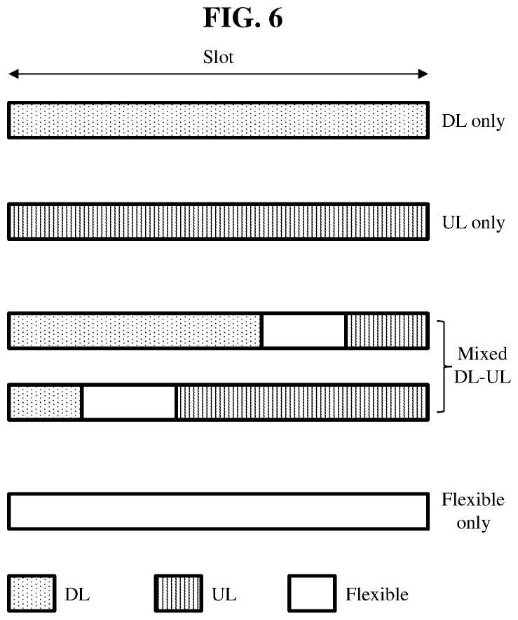

FIG. 6 illustrates slot structures used in a 3GPP-based system. In all 3GPP-based systems, for example, in an NR system, each slot may have a self-contained structure including i) a DL control channel, ii) DL or UL data, and/or iii) a UL control channel For example, the first N symbols in a slot may be used to transmit the DL control channel (hereinafter, DL control region) and the last M symbols in a slot may be used to transmit the UL control channel (hereinafter, UL control region), where N and M are integers other than negative numbers. A resource region (hereinafter, data region) between the DL control region and the UL control region may be used to transmit DL data or UL data. Symbols in a single slot may be divided into group(s) of consecutive symbols that may be used as DL symbols, UL symbols, or flexible symbols. Hereinbelow, information indicating how each symbol in slot(s) is used will be referred to as a slot format. For example, which symbols in slot(s) are used for UL and which symbols in slot(s) are used for DL may be defined by a slot format.

When a BS intends to operate a serving cell in time division duplex (TDD) mode, the BS may configure a pattern for UL and DL allocation for the serving cell through higher layer (e.g., RRC) signaling. For example, the following parameters may be used to configure a TDD DL-UL pattern:
dl-UL-TransmissionPeriodicity that provides a periodicity of the DL-UL pattern;
nrofDownlinkSlots that provides the number of consecutive full DL slots at the beginning of each DL-UL pattern, where the full DL slots are slots having only DL symbols;
nrofDownlinkSymbols that provides the number of consecutive DL symbols at the beginning of a slot immediately following the last full DL slot;
nrofUplinkSlots that provides the number of consecutive full UL slots at the end of each DL-UL pattern, where the full UL slots are slots having only UL symbols; and
nrofUplinkSymbols that provides the number of consecutive UL symbols in the end of a slot immediately preceding the first full UL slot.

The remaining symbols that are not configured as either DL symbols or UL symbols among symbols in the DL-UL pattern are flexible symbols.

If the UE is provided with a configuration for the TDD DL-UL pattern, i.e., a TDD UL-DL configuration (e.g., tdd-UL-DL-ConfigurationCommon, or tdd-UL-DLConfigurationDedicated), through higher layer signaling, the UE sets a slot format per slot over a number of slots based on the configuration.

For symbols, although there may be various combinations of DL symbols, UL symbols, and flexible symbols, a predetermined number of combinations may be predefined as slot formats and the predefined slot formats may be respectively identified by slot format indexes. The following table shows a part of the predefined slot formats. In the table below, D denotes a DL symbol, U denotes a UL symbol, and F denotes a flexible symbol.

TABLE 3

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | \|F | F | F | F | F | F | F | U |
| 20 | D | D | F | F | F | F | F | F | F | F | F | F | F | U |

| | |
|---|---|
| . . . | . . . |

To indicate which slot format is used in a specific slot among the predefined slot formats, the BS may configure a set of slot format combinations applicable to a corresponding serving cell per cell with respect to a set of serving cells through higher layer (e.g., RRC) signaling and cause the UE to monitor a group-common PDCCH for slot format indicator(s) (SFI(s)) through higher layer (e.g., RRC) signaling. Hereinafter, DCI carried by the group-common PDCCH for the SFI(s) will be referred to as SFI DCI. DCI format 2_0 is used as the SFI DCI. For example, for each serving cell in a set of serving cells, the BS may provide the UE with the (start) position of a slot format combination ID (i.e., SFI-index) for a corresponding serving cell in the SFI DCI, a set of slot format combinations applicable to the serving cell, and a reference subcarrier spacing configuration for each slot format in a slot format combination indicated by an SFI-index value in the SFI DCI. One or more slot formats are configured for each slot format combination in the set of the slot format combinations and the slot format combination ID (i.e., SFI-index) is assigned to the slot format combination. For example, when the BS intends to configure the slot format combination with N slot formats, N slot format indexes among slot format indexes for the predefined slot formats (e.g., see Table 3) may be indicated for the slot format combination. In order to configure the UE to monitor the group-common PDCCH for the SFIs, the BS informs the UE of an SFI-RNTI corresponding to an radio network temporary identifier (RNTI) used for an SFI and the total length of a DCI payload scrambled with the SFI-RNTI. Upon detecting the PDCCH based on the SFI-RNTI, the UE may determine slot format(s) for the corresponding serving cell from an SFI-index for the serving cell among SFI-indexes in the DCI payload in the PDCCH.

Symbols indicated as flexible symbols by the TDD DL-UL pattern configuration may be indicated as UL symbols, DL symbols, or flexible symbols by the SFI DCI. Symbols indicated as the DL/UL symbols by the TDD DL-UL pattern configuration are not overridden as the UL/DL symbols or the flexible symbols by the SFI DCI.

If the TDD DL-UL pattern is not configured, the UE determines whether each slot is used for UL or DL and determines symbol allocation in each slot based on the SFI DCI and/or on DCI for scheduling or triggering DL or UL signal transmission (e.g., DCI format 1_0, DCI format 1_1, DCI format 1_2, DCI format 0_0, DCI format 0_1, DCI format 0_2, or DCI format 2_3).

NR frequency bands are defined as two types of frequency ranges, i.e., FR1 and FR2. FR2 is also referred to as millimeter wave (mmW). The following table shows frequency ranges within which NR may operate.

TABLE 4

| Frequency | Corresponding | | |
|---|---|---|---|
| Range | frequency | Subcarrier | |
| designation | range | Spacing | |
| FR1 | 410 MHz-7125 MHz | 15, 30, 60 | KHz |
| FR2 | 24250 MHz-52600 MHz | 60, 120, 240 | kHz |

Hereinafter, physical channels that may be used in the 3GPP-based wireless communication system will be described in detail.

A PDCCH carries DCI. For example, the PDCCH (i.e., DCI) carries information about transport format and resource allocation of a downlink shared channel (DL-SCH), information about resource allocation of an uplink shared channel (UL-SCH), paging information about a paging channel (PCH), system information about the DL-SCH, information about resource allocation for a control message, such as a random access response (RAR) transmitted on a PDSCH, of a layer (hereinafter, higher layer) positioned higher than a physical layer among protocol stacks of the UE/BS, a transmit power control command, information about activation/deactivation of configured scheduling (CS), etc. DCI including resource allocation information on the DL-SCH is called PDSCH scheduling DCI, and DCI including resource allocation information on the UL-SCH is called PUSCH scheduling DCI. The DCI includes a cyclic redundancy check (CRC). The CRC is masked/scrambled with various identifiers (e.g., radio network temporary identifier (RNTI)) according to an owner or usage of the PDCCH. For example, if the PDCCH is for a specific UE, the CRS is masked with a UE identifier (e.g., cell-RNTI (C-RNTI)). If the PDCCH is for a paging message, the CRC is masked with a paging RNTI (P-RNTI). If the PDCCH is for system information (e.g., system information block (SIB)), the CRC is masked with a system information RNTI (SI-RNTI). If the PDCCH is for a random access response, the CRC is masked with a random access-RNTI (RA-RNTI).

When a PDCCH on one serving cell schedules a PDSCH or a PUSCH on another serving cell, it is referred to cross-carrier scheduling. Cross-carrier scheduling with a carrier indicator field (CIF) may allow a PDCCH on a serving cell to schedule resources on another serving cell. When a PDSCH on a serving cell schedules a PDSCH or a PUSCH on the serving cell, it is referred to as self-carrier scheduling. When the cross-carrier scheduling is used in a cell, the BS may provide information about a cell scheduling the cell to the UE. For example, the BS may inform the UE whether a serving cell is scheduled by a PDCCH on another (scheduling) cell or scheduled by the serving cell. If the serving cell is scheduled by the other (scheduling) cell, the BS may inform the UE which cell signals DL assignments and UL grants for the serving cell. In the present disclosure, a cell carrying a PDCCH is referred to as a scheduling cell, and a cell where transmission of a PUSCH or a PDSCH is scheduled by DCI included in the PDCCH, that is, a cell carrying the PUSCH or PDSCH scheduled by the PDCCH is referred to as a scheduled cell.

A PDSCH is a physical layer UL channel for UL data transport. The PDSCH carries DL data (e.g., DL-SCH transport block) and is subjected to modulation such as quadrature phase shift keying (QPSK), 16 quadrature amplitude modulation (QAM), 64 QAM, 256 QAM, etc. A codeword is generated by encoding a transport block (TB). The PDSCH may carry a maximum of two codewords. Scrambling and modulation mapping per codeword may be performed and modulation symbols generated from each codeword may be mapped to one or more layers. Each layer is mapped to a radio resource together with a DMRS and generated as an OFDM symbol signal. Then, the OFDM symbol signal is transmitted through a corresponding antenna port.

A PUCCH refers to a physical layer UL channel for UCI transmission. The PUCCH carries UCI. The UCI includes the following:
Scheduling request (SR): Information that is used to request a UL-SCH resource.
Hybrid automatic repeat request (HARQ)-acknowledgment (ACK): A response to a DL data packet (e.g., codeword) on the PDSCH. HARQ-ACK indicates whether the DL data packet has been successfully received by a communication device. In response to a single codeword, 1-bit HARQ-ACK may be transmitted. In response to two codewords, 2-bit HARQ-ACK may be transmitted. The HARQ-ACK response includes positive ACK (simply, ACK), negative ACK (NACK), discontinuous transmission (DTX), or NACK/DTX. Here, the term HARQ-ACK is used interchangeably with HARQ ACK/NACK, ACK/NACK, or A/N.
Channel state information (CSI): Feedback information about a DL channel. The CSI may include channel quality information (CQI), a rank indicator (RI), a precoding matrix indicator (PMI), a CSI-RS resource indicator (CSI), an SS/PBCH resource block indicator (SSBRI), and a layer indicator (L1). The CSI may be classified into CSI part 1 and CSI part 2 according to UCI type included in the CSI. For example, the CRI, RI, and/or the CQI for the first codeword may be included in CSI part 1, and LI, PMI, and/or the CQI for the second codeword may be included in CSI part 2.

In the present disclosure, for convenience, PUCCH resources configured/indicated for/to the UE by the BS for HARQ-ACK, SR, and CSI transmission are referred to as a HARQ-ACK PUCCH resource, an SR PUCCH resource, and a CSI PUCCH resource, respectively.

PUCCH formats may be defined as follows according to UCI payload sizes and/or transmission lengths (e.g., the number of symbols included in PUCCH resources). In regard to the PUCCH formats, reference may also be made to Table 5.

### (0) PUCCH Format 0 (PF0 or F0)

Supported UCI payload size: up to K bits (e.g., K=2)
Number of OFDM symbols constituting a single PUCCH: 1 to X symbols (e.g., X=2)
Transmission structure: Only a UCI signal without a DMRS is included in PUCCH format 0. The UE transmits a UCI state by selecting and transmitting one of a plurality of sequences. For example, the UE transmits specific UCI to the BS by transmitting one of a plurality of sequences through a PUCCH, which is PUCCH format 0. The UE transmits the PUCCH, which is PUCCH format 0, in PUCCH resources for a corresponding SR configuration only upon transmitting a positive SR.
Configuration for PUCCH format 0 includes the following parameters for a corresponding PUCCH resource: an index for initial cyclic shift, the number of symbols for PUCCH transmission, and/or the first symbol for PUCCH transmission.

### (1) PUCCH Format 1 (PF1 or F1)

Supported UCI payload size: up to K bits (e.g., K=2)
Number of OFDM symbols constituting a single PUCCH: Y to Z symbols (e.g., Y=4 and Z=14)
Transmission structure: The DMRS and UCI are configured/mapped in TDM in/to different OFDM symbols. In other words, the DMRS is transmitted in symbols in which modulation symbols are not transmitted and the UCI is represented as the product between a specific sequence (e.g., orthogonal cover code (OCC)) and a modulation (e.g., QPSK) symbol. Code division multiplexing (CDM) is supported between a plurality of PUCCH resources (conforming to PUCCH format 1) (within the same RB) by applying cyclic shifts (CSs)/OCCs to both the UCI and the DMRS. PUCCH format 1 carries the UCI of up to 2 bits and the modulation symbols are spread by the OCC (differently configured depending on whether frequency hopping is performed) in the time domain.
Configuration for PUCCH format 1 includes the following parameters for a corresponding PUCCH resource: an index for initial cyclic shift, the number of symbols for PUCCH transmission, the first symbol for PUCCH transmission, and/or an index for the OCC.

### (2) PUCCH Format 2 (PF2 or F2)

Supported UCI payload size: more than K bits (e.g., K=2)
Number of OFDM symbols constituting a single PUCCH: 1 to X symbols (e.g., X=2)
Transmission structure: The DMRS and UCI are configured/mapped using frequency division multiplexing (FDM) within the same symbol. The UE transmits the UCI by applying only IFFT without DFT to encoded UCI bits. PUCCH format 2 carries UCI of a larger bit size than K bits and modulation symbols are subjected to FDM with the DMRS, for transmission. For example, the DMRS is located in symbol indexes #1, #4, #7, and #10 within a given RB with the density of ⅓. A pseudo noise (PN) sequence is used for a DMRS sequence. Frequency hopping may be activated for 2-symbol PUCCH format 2.
Configuration for PUCCH format 2 includes the following parameters for a corresponding PUCCH resource: the number of PRBs, the number of symbols for PUCCH transmission, and/or the first symbol for PUCCH transmission.

### (3) PUCCH Format 3 (PF3 or F3)

Supported UCI payload size: more than K bits (e.g., K=2)
Number of OFDM symbols constituting a single PUCCH: Y to Z symbols (e.g., Y=4 and Z=14)
Transmission structure: The DMRS and UCI are configured/mapped in TDM for/to different OFDM symbols. The UE transmits the UCI by applying DFT to encoded UCI bits. PUCCH format 3 does not support UE multiplexing for the same time-frequency resource (e.g., same PRB).

Configuration for PUCCH format 3 includes the following parameters for a corresponding PUCCH resource: the number of PRBs, the number of symbols for PUCCH transmission, and/or the first symbol for PUCCH transmission.

### (4) PUCCH Format 4 (PF4 or F4)

Supported UCI payload size: more than K bits (e.g., K=2)
Number of OFDM symbols constituting a single PUCCH: Y to Z symbols (e.g., Y=4 and Z=14)
Transmission structure: The DMRS and UCI are configured/mapped in TDM for/to different OFDM symbols. PUCCH format 4 may multiplex up to 4 UEs in the same PRB, by applying an OCC at the front end of DFT and applying a CS (or interleaved FDM (IFDM) mapping) to the DMRS. In other words, modulation symbols of the UCI are subjected to TDM with the DMRS, for transmission.
Configuration for PUCCH format 4 includes the following parameters for a corresponding PUCCH resource: the number of symbols for PUCCH transmission, length for the OCC, an index for the OCC, and the first symbol for PUCCH transmission.

The table below shows the PUCCH formats. The PUCCH formats may be divided into short PUCCH formats (formats 0 and 2) and long PUCCH formats (formats 1, 3, and 4) according to PUCCH transmission length.

TABLE 5

| | Length in | | | |
|---|---|---|---|---|
| | OFDM | | | |
| PUCCH | symbols | Number | | |
| format | N^{PUCCH}_{symb} | of bits | Usage | Etc. |
| 0 | 1-2 | =<2 | HARQ, SR | Sequence selection |
| 1 | 4-14 | =<2 | HARQ, [SR] | Sequence modulation |
| 2 | 1-2 | >2 | HARQ, CSI, [SR] | CP-OFDM |
| 3 | 4-14 | >2 | HARQ, CSI, [SR] | DFT-s-OFDM |
| | | | | (no UE multiplexing) |
| 4 | 4-14 | >2 | HARQ, CSI, [SR] | DFT-s-OFDM |
| | | | | (Pre DFT OCC) |

A PUCCH resource may be determined according to a UCI type (e.g., A/N, SR, or CSI). A PUCCH resource used for UCI transmission may be determined based on a UCI (payload) size. For example, the BS may configure a plurality of PUCCH resource sets for the UE, and the UE may select a specific PUCCH resource set corresponding to a specific range according to the range of the UCI (payload) size (e.g., numbers of UCI bits). For example, the UE may select one of the following PUCCH resource sets according to the number of UCI bits, N_{UCI}.
PUCCH resource set #0, if the number of UCI bits=<2
PUCCH resource set #1, if 2<the number of UCI bits=<N1

. . .
PUCCH resource set #(K-1), if NK-2<the number of UCI bits=<NK-1

Here, K represents the number of PUCCH resource sets (K>1) and Nᵢ represents a maximum number of UCI bits supported by PUCCH resource set #i. For example, PUCCH resource set #1 may include resources of PUCCH formats 0 to 1, and the other PUCCH resource sets may include resources of PUCCH formats 2 to 4 (see Table 5).

Configuration for each PUCCH resource includes a PUCCH resource index, a start PRB index, and configuration for one of PUCCH format 0 to PUCCH format 4. The UE is configured with a code rate for multiplexing HARQ-ACK, SR, and CSI report(s) within PUCCH transmission using PUCCH format 2, PUCCH format 3, or PUCCH format 4, by the BS through a higher layer parameter maxCodeRate. The higher layer parameter maxCodeRate is used to determine how to feed back the UCI on PUCCH resources for PUCCH format 2, 3, or 4.

If the UCI type is SR and CSI, a PUCCH resource to be used for UCI transmission in a PUCCH resource set may be configured for the UE through higher layer signaling (e.g., RRC signaling). If the UCI type is HARQ-ACK for a semi-persistent scheduling (SPS) PDSCH, the PUCCH resource to be used for UCI transmission in the PUCCH resource set may be configured for the UE through higher layer signaling (e.g., RRC signaling). On the other hand, if the UCI type is HARQ-ACK for a PDSCH scheduled by DCI, the PUCCH resource to be used for UCI transmission in the PUCCH resource set may be scheduled by the DCI.

In the case of DCI-based PUCCH resource scheduling, the BS may transmit the DCI to the UE on a PDCCH and indicate a PUCCH resource to be used for UCI transmission in a specific PUCCH resource set by an ACK/NACK resource indicator (ARI) in the DCI. The ARI may be used to indicate a PUCCH resource for ACK/NACK transmission and also be referred to as a PUCCH resource indicator (PRI). Here, the DCI may be used for PDSCH scheduling and the UCI may include HARQ-ACK for a PDSCH. The BS may configure a PUCCH resource set including a larger number of PUCCH resources than states representable by the ARI by (UE-specific) higher layer (e.g., RRC) signaling for the UE. The ARI may indicate a PUCCH resource subset of the PUCCH resource set and which PUCCH resource in the indicated PUCCH resource subset is to be used may be determined according to an implicit rule based on transmission resource information about the PDCCH (e.g., the starting CCE index of the PDCCH).

For UL-SCH data transmission, the UE should include UL resources available for the UE and, for DL-SCH data reception, the UE should include DL resources available for the UE. The UL resources and the DL resources are assigned to the UE by the BS through resource allocation. Resource allocation may include time domain resource allocation (TDRA) and frequency domain resource allocation (FDRA). In the present disclosure, UL resource allocation is also referred to as a UL grant and DL resource allocation is referred to as DL assignment. The UL grant is dynamically received by the UE on the PDCCH or in RAR or semi-persistently configured for the UE by the BS through RRC signaling. DL assignment is dynamically received by the UE on the PDCCH or semi-persistently configured for the UE by the BS through RRC signaling.

On UL, the BS may dynamically allocate UL resources to the UE through PDCCH(s) addressed to a cell radio network temporary Identifier (C-RNTI). The UE monitors the PDCCH(s) in order to discover possible UL grant(s) for UL transmission. The BS may allocate the UL resources using a configured grant to the UE. Two types of configured grants, Type 1 and Type 2, may be used. In Type 1, the BS directly provides the configured UL grant (including periodicity) through RRC signaling. In Type 2, the BS may configure a periodicity of an RRC-configured UL grant through RRC signaling and signal, activate, or deactivate the configured UL grant through the PDCCH addressed to a configured scheduling RNTI (CS-RNTI). For example, in Type 2, the PDCCH addressed to the CS-RNTI indicates that the corresponding UL grant may be implicitly reused according to the configured periodicity through RRC signaling until deactivation.

On DL, the BS may dynamically allocate DL resources to the UE through PDCCH(s) addressed to the C-RNTI. The UE monitors the PDCCH(s) in order to discover possible DL grant(s). The BS may allocate the DL resources to the UE using SPS. The BS may configure a periodicity of configured DL assignment through RRC signaling and signal, activate, or deactivate the configured DL assignment through the PDCCH addressed to the CS-RNTI. For example, the PDCCH addressed to the CS-RNTI indicates that the corresponding DL assignment may be implicitly reused according to the configured periodicity through RRC signaling until deactivation.

Hereinafter, resource allocation by the PDCCH and resource allocation by RRC will be described in more detail.

*Resource Allocation by PDCCH: dynamic grant/assignment

The PDCCH may be used to schedule DL transmission on the PDSCH and UL transmission on the PUSCH. DCI on the PDCCH for scheduling DL transmission may include DL resource assignment that at least includes a modulation and coding format (e.g., modulation and coding scheme (MCS)) index IMcs), resource allocation, and HARQ information, associated with a DL-SCH. DCI on the PDCCH for scheduling UL transmission may include a UL scheduling grant that at least includes a modulation and coding format, resource allocation, and HARQ information, associated with a UL-SCH. HARQ information for a DL-SCH or a UL-SCH may include a new data indicator (NDI), a transport block size (TBS), a redundancy version (RV), and a HARQ process ID (i.e., a HARQ process number box). The size and usage of the DCI carried by one PDCCH differs according to a DCI format. For example, DCI format 0_0, DCI format 0_1, or DCI format 0_2 may be used to schedule the PUSCH, and DCI format 1_0, DCI format 1_1, or DCI format 1_2 may be used to schedule the PDSCH. Particularly, DCI format 0_2 and DCI format 1_2 may be used to schedule transmission having higher transmission reliability and lower latency requirements than transmission reliability and latency requirement guaranteed by DCI format 0_0, DCI format 0_1, DCI format 1_0, or DCI format 1_1. Some implementations of the present disclosure may be applied to UL data transmission based on DCL format 0_2. Some implementations of the present disclosure may be applied to DL data reception based on DCI format 1_2.

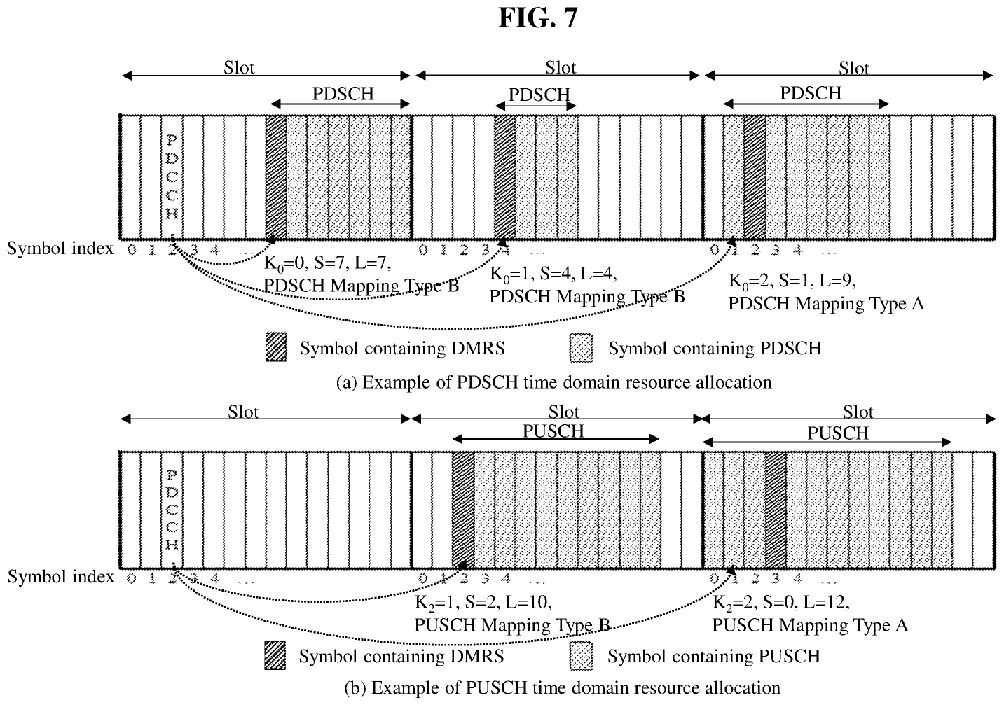

FIG. 7 illustrates an example of PDSCH TDRA caused by a PDCCH and an example of PUSCH TDRA caused by the PDCCH.

DCI carried by the PDCCH in order to schedule a PDSCH or a PUSCH includes a TDRA field. The TDRA field provides a value m for a row index m+1 to an allocation table for the PDSCH or the PUSCH. Predefined default PDSCH time domain allocation is applied as the allocation table for the PDSCH or a PDSCH TDRA table that the BS configures through RRC signaled pdsch-TimeDomainAllocationList is applied as the allocation table for the PDSCH. Predefined default PUSCH time domain allocation is applied as the allocation table for the PUSCH or a PUSCH TDRA table that the BS configures through RRC signaled pusch-TimeDomainAllocationList is applied as the allocation table for the PUSCH. The PDSCH TDRA table to be applied and/or the PUSCH TDRA table to be applied may be determined according a fixed/predefined rule (e.g., refer to 3GPP TS 38.214).

In PDSCH time domain resource configurations, each indexed row defines a DL assignment-to-PDSCH slot offset K₀, a start and length indicator SLIV (or directly, a start position (e.g., start symbol index S) and an allocation length (e.g., the number of symbols, L) of the PDSCH in a slot), and a PDSCH mapping type. In PUSCH time domain resource configurations, each indexed row defines a UL grant-to-PUSCH slot offset K₂, a start position (e.g., start symbol index S) and an allocation length (e.g., the number of symbols, L) of the PUSCH in a slot, and a PUSCH mapping type. K₀ for the PDSCH and K₂ for the PUSCH indicate the difference between the slot with the PDCCH and the slot with the PDSCH or PUSCH corresponding to the PDCCH. SLIV denotes a joint indicator of the start symbol S relative to the start of the slot with the PDSCH or PUSCH and the number of consecutive symbols, L, counting from the symbol S. There are two PDSCH/PUSCH mapping types: one is mapping type A and the other is mapping type B. In the case of PDSCH/PUSCH mapping type A, a DMRS is mapped to a PDSCH/PUSCH resource with respect to the start of a slot. One or two of the symbols of the PDSCH/PUSCH resource may be used as DMRS symbol(s) according to other DMRS parameters. For example, in the case of PDSCH/PUSCH mapping type A, the DMRS is located in the third symbol (symbol #2) or the fourth symbol (symbol #3) in the slot according to RRC signaling. In the case of PDSCH/PUSCH mapping type B, a DMRS is mapped with respect to the first OFDM symbol of a PDSCH/PUSCH resource. One or two symbols from the first symbol of the PDSCH/PUSCH resource may be used as DMRS symbol(s) according to other DMRS parameters. For example, in the case of PDSCH/PUSCH mapping type B, the DMRS is located at the first symbol allocated for the PDSCH/PUSCH. In the present disclosure, the PDSCH/PUSCH mapping type may be referred to as a mapping type or a DMRS mapping type. For example, in the present disclosure, PUSCH mapping type A may be referred to as mapping type A or DMRS mapping type A, and PUSCH mapping type B may be referred to as mapping type B or DMRS mapping type B.

The scheduling DCI includes an FDRA field that provides assignment information about RBs used for the PDSCH or the PUSCH. For example, the FDRA field provides information about a cell for PDSCH or PUSCH transmission to the UE, information about a BWP for PDSCH or PUSCH transmission, and/or information about RBs for PDSCH or PUSCH transmission.

*Resource Allocation by RRC

As mentioned above, there are two types of transmission without dynamic grant: configured grant Type 1 and configured grant Type 2. In configured grant Type 1, a UL grant is provided by RRC and stored as a configured UL grant. In configured grant Type 2, the UL grant is provided by the PDCCH and stored or cleared as the configured UL grant based on L1 signaling indicating configured UL grant activation or deactivation. Type 1 and Type 2 may be configured by RRC per serving cell and per BWP. Multiple configurations may be active simultaneously on different serving cells.

When configured grant Type 1 is configured, the UE may be provided with the following parameters through RRC signaling:
cs-RNTI corresponding to a CS-RNTI for retransmission;
periodicity corresponding to a periodicity of configured grant Type 1;
timeDomainOffset indicating an offset of a resource with respect to system frame number (SFN)=0 in the time domain;
timeDomainAllocation value m that provides a row index m+1 pointing to the allocation table, indicating a combination of the start symbol S, the length L, and the PUSCH mapping type;
frequencyDomainAllocation that provides frequency domain resource allocation; and
mcsAndTBS that provides I_{MCS} indicating a modulation order, a target code rate, and a transport block size.

Upon configuration of configured grant Type 1 for a serving cell by RRC, the UE stores the UL grant provided by RRC as a configured UL grant for an indicated serving cell and initializes or re-initializes the configured UL grant to start in a symbol according to timeDomainOffset and S (derived from SLIV) and to recur with periodicity. After the UL grant is configured for configured grant Type 1, the UE may consider that the UL grant recurs in association with each symbol satisfying: [(SFN*numberOfSlotsPerFrame (numberOfSymbolsPerSlot)+(slot number in the frame*numberOfSymbolsPerSlot)+symbol number in the slot]=(timeDomainOffset*numberOfSymbolsPerSlot+S+N*periodicity) modulo (1024*numberOfSlotsPerFrame*numberOfSymbolsPerSlot), for all N>=0, where numberOfSlotsPerFrame and numberOfSymbolsPerSlot indicate the number of consecutive slots per frame and the number of consecutive OFDM symbols per slot, respectively (refer to Table 1 and Table 2).

For configured grant Type 2, the UE may be provided with the following parameters by the BS through RRC signaling:
cs-RNTI corresponding to a CS-RNTI for activation, deactivation, and retransmission; and
periodicity that provides a periodicity of configured grant Type 2.

An actual UL grant is provided to the UE by the PDCCH (addressed to the CS-RNTI). After the UL grant is configured for configured grant Type 2, the UE may consider that the UL grant recurs in association with each symbol satisfying: [(SFN*numberOfSlotsPerFrame*numberOfSymbolsPerSlot)+(slot number in the frame*numberOfSymbolsPerSlot)+symbol number in the slot]=[(SFN_{start time}*numberOfSlotsPerFrame*numberOfSymbolsPerSlot+slot_{start time}*numberOfSymbolsPerSlot+symbol_{start time})+N*periodicity] modulo (1024* numberOfSlotsPerFrame*numberOfSymbolsPerSlot), for all N>=0, where SFN_{start time}, slot_{start time}, and symbol_{start time} represent an SFN, a slot, and a symbol, respectively, of the first transmission opportunity of the PUSCH after the configured grant is (re-)initialized, and numberOfSlotsPerFrame and numberOfSymbolsPerSlot indicate the number of consecutive slots per frame and the number of consecutive OFDM symbols per slot, respectively (refer to Table 1 and Table 2).

In some scenarios, parameters harq-ProcID-Offset and/or harq-ProcID-Offset2 used to derive HARQ process IDs for configured uplink grants may be further provided to the UE by the BS. harq-ProclD-Offset may be an offset of a HARQ process for the configured grant for an operation with shared spectrum channel access, and harq-ProcID-Offset2 may be offset of an HARQ process for the configured grant. In the present disclosure, cg-RetransmissionTimer is a duration during which the UE needs not automatically perform retransmission using an HARQ process of the (re)transmission after (re)transmission based on the configured grant and is a parameter to be provided to the UE by the BS when retransmission is configured on the configured uplink grant. For grants in which harq-ProclD-Offset and cg-RetransmissionTimer are not configured, a HARQ process ID associated with a first symbol of UL transmission may be derived from the following equation: HARQ Process ID=[floor(CURRENT_symbol/periodicity)] modulo nrofHARQ-Processes. For uplink grants in which harq-ProcID-Offset2 is configured, a HARQ process ID associated with the first symbol of UL transmission may be derived from the following equation: HARQ Process ID=[floor(CURRENT_symbol/periodicity)] modulo nrofHARQ-Processes+harq-ProcID-Offset2, where CURRENT_symbol=(SFN*numberOfSlotsPerFrame*numberOfSymbolsPerSlot+slot number in the frame*numberOfSymbolsPerSlot+symbol number in the slot), and numberOfSlotsPerFrame and numberOfSymbolsPerSlot are the number of consecutive slots per frame and the number of consecutive OFDM symbols per slot. For the UL grants configured with cg-RetransmissionTimer, the UE may select an HARQ process ID from among HARQ process IDs available for grant configuration arbitrarily configured.

On DL, the UE may be configured with semi-persistent scheduling (SPS) per serving cell and per BWP by RRC signaling from the BS. For DL SPS, DL assignment is provided to the UE by the PDCCH and stored or cleared based on L1 signaling indicating SPS activation or deactivation. When SPS is configured, the UE may be provided with the following parameters by the BS through RRC signaling:
cs-RNTI corresponding to a CS-RNTI for activation, deactivation, and retransmission;
nrofHARQ-Processes that provides the number of HARQ processes for SPS;
periodicity that provides a periodicity of configured DL assignment for SPS; and
n1PUCCH-AN that provides a HARQ resource for a PUCCH for SPS (the network configures the HARQ resource as format 0 or format 1, and the actual PUCCH resource is configured by PUCCH-Config and referred to in n1PUCCH-AN by the ID thereof).

After DL assignment is configured for SPS, the UE may consider sequentially that N-th DL assignment occurs in a slot satisfying: (numberOfSlotsPerFrame*SFN+slot number in the frame)=[(numberOfSlotsPerFrame*SFN_{start time}+slot_{start time}) N*periodicity*numberOfSlotsPerFrame/10] modulo (1024*numberOfSlotsPerFrame), where SFN_{start time} and slot_{start time} represent an SFN and a slot, respectively, of first transmission of the PDSCH after configured DL assignment is (re-)initialized, and numberOfSlotsPerFrame and numberOfSymbolsPerSlot indicate the number of consecutive slots per frame and the number of consecutive OFDM symbols per slot, respectively (refer to Table 1 and Table 2).

In some scenarios, a parameter harq-ProclD-Offset used to derive HARQ process IDs for configured downlink assignments may be further provided to the UE by the BS. harq-ProcID-Offset may be an offset of a HARQ process for SPS. For configured downlink assignments without harq-ProclD-Offset, a HARQ process ID associated with a slot in which DL transmission starts may be determined from the following equation: HARQ Process ID=[floor (CURRENT_slot*10/(numberOfSlotsPerFrame*periodicity))] modulo nrofHARQ-Processes, where CURRENT_slot=[(SFN*numberOfSlotsPerFrame)+slot number in the frame], and numberOfSlotsPerFrame means the number of consecutive slots per frame. For configured downlink assignments with harq-ProcID-Offset, a HARQ process ID associated with a slot in which DL transmission starts may be determined from the following equation: HARQ Process ID=[floor (CURRENT_slot/periodicity)] modulo nrofHARQ-Processes+harq-ProcID-Offset, where CURRENT_slot=[(SFN*numberOfSlotsPerFrame)+slot number in the frame] and numberOfSlotsPerFrame means the number of consecutive slots per frame.

If the CRC of a corresponding DCI format is scrambled with the CS-RNTI provided by the RRC parameter cs-RNTI, and a new data indicator field for an enabled transport block is set to 0, the UE validates, for scheduling activation or scheduling release, a DL SPS assignment PDCCH or a configured UL grant Type 2 PDCCH. Validation of the DCI format is achieved if all fields for the DCI format are set according to Table 6 and Table 7. Table 6 shows an example of special fields for DL SPS and UL grant Type 2 scheduling activation PDCCH validation, and Table 7 shows an example of special fields for DL SPS and UL grant Type 2 scheduling release PDCCH validation.

TABLE 6

| | DCI format 0_0/0_1 | DCI format 1_0 | DCI format 1_1 |
|---|---|---|---|
| HARQ | set to all ‘0’s | set to all ‘0’s | set to all ‘0’s |
| process | | | |
| number | | | |
| Redun- | set to ‘00’ | set to ‘00’ | For the enabled |
| dancy | | | transport block: |
| version | | | set to ‘00’ |

| | DCI format 0_0 | DCI format 1_0 |
|---|---|---|
| HARQ process number | set to all ‘0’s | set to all ‘0’s |
| Redundancy version | set to ‘00’ | set to ‘00’ |
| Modulation and coding | set to all ‘1’s | set to all ‘1’s |
| scheme | | |
| Resource block | set to all ‘1’s | set to all ‘1’s |
| assignment | | |

Actual DL assignment and UL grant for DL SPS or UL grant Type 2, and a corresponding MCS are provided by resource assignment fields (e.g., a TDRA field providing a TDRA value m, an FDRA field providing frequency resource block assignment, and/or an MCS field) in the DCI format carried by a corresponding DL SPS or UL grant Type 2 scheduling activation PDCCH. If validation is achieved, the UE considers information in the DCI format as valid activation or valid release of DL SPS or configured UL grant Type 2.

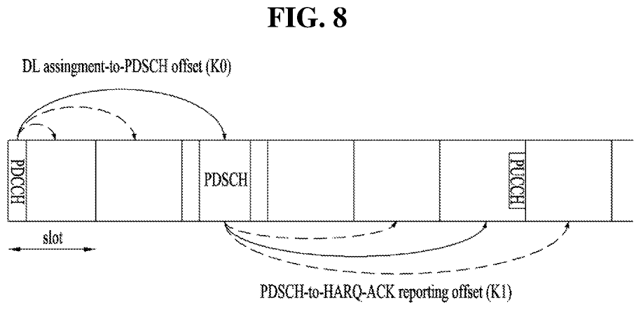

FIG. 8 illustrates a HARQ-ACK transmission/reception procedure.

Referring to FIG. 8, the UE may detect a PDCCH in a slot n. Next, the UE may receive a PDSCH in a slot n+K0 according to scheduling information received through the PDCCH in the slot n and then transmit UCI through a PUCCH in a slot n+K1. In this case, the UCI includes a HARQ-ACK response for the PDSCH.

The DCI (e.g., DCI format 1_0 or DCI format 1_1) carried by the PDCCH for scheduling the PDSCH may include the following information.
FDRA: FDRA indicates an RB set allocated to the PDSCH.
TDRA: TDRA indicates a DL assignment-to-PDSCH slot offset K0, the start position (e.g., symbol index S) and length (e.g., the number of symbols, L) of the PDSCH in a slot, and the PDSCH mapping type. PDSCH mapping Type A or PDSCH mapping Type B may be indicated by TDRA. For PDSCH mapping Type A, the DMRS is located in the third symbol (symbol #2) or fourth symbol (symbol #3) in a slot. For PDSCH mapping Type B, the DMRS is allocated in the first symbol allocated for the PDSCH.
PDSCH-to-HARQ_feedback timing indicator: This indicator indicates K1.

If the PDSCH is configured to transmit a maximum of one TB, a HARQ-ACK response may consist of one bit. If the PDSCH is configured to transmit a maximum of 2 TBs, the HARQ-ACK response may consist of 2 bits when spatial bundling is not configured and one bit when spatial bundling is configured. When a HARQ-ACK transmission timing for a plurality of PDSCHs is designated as slot n+K1, UCI transmitted in slot n+K1 includes a HARQ-ACK response for the plural PDSCHs.

In the present disclosure, a HARQ-ACK payload consisting of HARQ-ACK bit(s) for one or plural PDSCHs may be referred to as a HARQ-ACK codebook. The HARQ-ACK codebook may be categorized as a semi-static HARQ-ACK codebook and a dynamic HARQ-ACK codebook.

In the case of the semi-static HARQ-ACK codebook, parameters related to a HARQ-ACK payload size that the UE is to report are semi-statically determined by a (UE-specific) higher layer (e.g., RRC) signal. The HARQ-ACK payload size of the semi-static HARQ-ACK codebook, e.g., the (maximum) HARQ-ACK payload (size) transmitted through one PUCCH in one slot, may be determined based on the number of HARQ-ACK bits corresponding to a combination (hereinafter, bundling window) of all DL carriers (i.e., DL serving cells) configured for the UE and all DL scheduling slots (or PDSCH transmission slots or PDCCH monitoring slots) for which the HARQ-ACK transmission timing may be indicated. That is, in a semi-static HARQ-ACK codebook scheme, the size of the HARQ-ACK codebook is fixed (to a maximum value) regardless of the number of actually scheduled DL data. For example, DL grant DCI (PDCCH) includes PDSCH-to-HARQ-ACK timing information, and the PDSCH-to-HARQ-ACK timing information may have one (e.g., k) of a plurality of values. For example, when the PDSCH is received in slot #m and the PDSCH-to-HARQ-ACK timing information in the DL grant DCI (PDCCH) for scheduling the PDSCH indicates k, the HARQ-ACK information for the PDSCH may be transmitted in slot #(m+k). As an example, k∈{1, 2, 3, 4, 5, 6, 7, 8}. When the HARQ-ACK information is transmitted in slot #n, the HARQ-ACK information may include possible maximum HARQ-ACK based on the bundling window. That is, HARQ-ACK information of slot #n may include HARQ-ACK corresponding to slot #(n−k). For example, when k∈{1, 2, 3, 4, 5, 6, 7, 8}, the HARQ-ACK information of slot #n may include HARQ-ACK corresponding to slot #(n−8) to slot #(n−1) regardless of actual DL data reception (i.e., HARQ-ACK of a maximum number). Here, the HARQ-ACK information may be replaced with a HARQ-ACK codebook or a HARQ-ACK payload. A slot may be understood/replaced as/with a candidate occasion for DL data reception. As described in the example, the bundling window may be determined based on the PDSCH-to-HARQ-ACK timing based on a HARQ-ACK slot, and a PDSCH-to-HARQ-ACK timing set may have predefined values (e.g., {1, 2, 3, 4, 5, 6, 7, 8}) or may be configured by higher layer (RRC) signaling. In the case of the dynamic HARQ-ACK codebook, the HARQ-ACK payload size that the UE is to report may be dynamically changed by the DCI etc. For example, in the dynamic HARQ-ACK codebook scheme, DL scheduling DCI may include a counter-DAI (i.e., c-DAI) and/or a total-DAI (i.e., t-DAI). Here, the DAI indicates a downlink assignment index and is used for the BS to inform the UE of transmitted or scheduled PDSCH(s) for which HARQ-ACK(s) are to be included in one HARQ-ACK transmission. Particularly, the c-DAI is an index indicating order between PDCCHs carrying DL scheduling DCI (hereinafter, DL scheduling PDCCHs), and t-DAI is an index indicating the total number of DL scheduling PDCCHs up to a current slot in which a PDCCH with the t-DAI is present.

In the NR system, a method of implementing a plurality of logical networks in a single physical network is considered. The logical networks need to support services with various requirements (e.g., eMBB, mMTC, URLLC, etc.). Accordingly, a physical layer of NR is designed to support a flexible transmission structure in consideration of the various service requirements. As an example, the physical layer of NR may change, if necessary, an OFDM symbol length (OFDM symbol duration) and a subcarrier spacing (SCS) (hereinafter, OFDM numerology). Transmission resources of physical channels may also be changed in a predetermined range (in units of symbols). For example, in NR, a PUCCH (resource) and a PUSCH (resource) may be configured to flexibly have a transmission length/transmission start timing within a predetermined range.

A control resource set (CORESET), which is a set of time-frequency resources on which the UE is capable of monitoring a PDCCH, may be defined and/or configured. One or more CORESETs may be configured for the UE. The CORESET consists of a set of PRBs with a duration of 1 to 3 OFDM symbols. The PRBs and a CORESET duration that constitute the CORESET may be provided to the UE through higher layer (e.g., RRC) signaling. A set of PDCCH candidates in the configured CORESET(s) is monitored according to corresponding search space sets. In the present disclosure, monitoring implies decoding (called blind decoding) each PDCCH candidate according to monitored DCI formats. A master information block (MIB) on a PBCH provides the UE with parameters (e.g., CORESET #0) for monitoring a PDCCH for scheduling a PDSCH carrying system information block 1 (SIB1). The PBCH may indicate that there is no associated SIB1. In this case, the UE is informed of not only a frequency range within which it may be assumed that there is no SSB associated with SSB1 but also another frequency range within which the SSB associated with SIB1 is to be discovered. CORESET #0, which is a CORESET for scheduling at least SIB1, may be configured through either the MIB or dedicated RRC signaling.

A set of the PDCCH candidates monitored by the UE is defined in terms of PDCCH search space sets. A search space set may be common search space (CSS) set or UE-specific search space (USS) set. Each CORESET configuration is associated with one or more search space sets and each search space set is associated with one CORESET configuration. The search space set s is determined based on the following parameters provided by the BS to the UE.
controlResourceSetId: An indicator for identifying a CORESET p associated with the search space set s;
monitoringSlotPeriodicityAndOffset: A PDCCH monitoring periodicity of kₛ slots and a PDCCH monitoring offset of oₛ slots for configuring slots for PDCCH monitoring;
duration: a duration of Tₛ<kₛ slots indicating the number of slots in which the search space set s exists;
monitoringSymbolsWithinSlot: A PDCCH monitoring pattern in a slot, indicating the first symbol(s) of the CORESET in a slot for PDCCH monitoring;
nrofCandidates: The number of PDCCH candidates per control channel element (CCE) aggregation level; and
searchSpaceType: an indication that the search space set s is either a CCE set or a USS set.

The UE monitors PDCCH candidates only in PDCCH monitoring occasions. The UE determines the PDCCH monitoring occasions from a PDCCH monitoring periodicity, a PDCCH monitoring offset, and a PDCCH monitoring pattern in a slot. Parameter monitoringSymbolsWithinSlot indicates, for example, the first symbol(s) for PDCCH monitoring in slots configured for PDCCH monitoring (e.g., refer to parameters monitoringSlotPeriodicityAndOffset and duration). For example, if monitoringSymbolsWithinSlot is 14 bit, the bit of monitoringSymbolsWithinSlot may represent 14 OFDM symbols of a slot, respectively, such that the most significant (left) bit represents the first OFDM symbol in the slot and the second most significant (left) bit represents the second OFDM symbol in the slot. For example, bit(s) set to 1 among the bit in monitoringSymbolsWithinSlot identify the first symbol(s) of the CORESET in the slot.

The UE monitors PDCCH candidates only on PDCCH monitoring occasions. The UE determines PDCCH monitoring occasions on an active DL BWP within a slot based on a PDCCH monitoring periodicity, a PDCCH monitoring offset, and a PDCCH monitoring pattern. In some implementations, for the search space set s, the UE may determine that PDCCH monitoring occasion(s) exist in a slot numbered n^{u}_{s,f} within a frame numbered n_{f} if (n_{f}*N^{frame,u}ₛₗₒₜ+n^{u}_{s,f}−oₛ) mod kₛ=0. That is, the UE monitors PDCCH candidates for the search space set s in Tₛ consecutive slots, starting from slot n^{u}_{s,f}, but the UE does not monitor the PDCCH candidates for the search space set s in subsequent kₛ−Tₛ consecutive slots.

Table 8 below shows RNTIs and uses cases, which are associated with search space sets.

TABLE 8

| | Search | | |
|---|---|---|---|
| Type | Space | RNTI | Use Case |
| Type0- | Common | SI-RNTI on a | SIB Decoding |
| PDCCH | | primary cell | |
| Type0A- | Common | SI-RNTI on a | SIB Decoding |
| PDCCH | | primary cell | |
| Type1- | Common | RA-RNTI or | Msg2, Msg4 |
| PDCCH | | TC-RNTI on | decoding in |
| | | a primary cell | RACH |
| Type2- | Common | P-RNTI on a | Paging Decoding |
| PDCCH | | primary cell | |
| Type3- | Common | INT-RNTI, SFI-RNTI, | |
| PDCCH | | TPC-PUSCH-RNTI, | |
| | | TPC-PUCCH-RNTI, | |
| | | TPC-SRS-RNTI, C- | |
| | | RNTI, MCS-C-RNTI, | |
| | | or CS-RNTI(s) | |
| | UE Specific | C-RNTI, or MCS- | User specific |
| | | C-RNTI, orCS-RNTI(s) | PDSCH decoding |

The following table shows DCI formats which are capable of being carried by a PDCCH.

TABLE 9

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the |
| | slot format |
| 2_1 | Notifying a group of UEs of the |
| | PRB(s) and OFDM symbol(s) where |
| | UE may assume no transmission is |
| | intended for the UE |
| 2_2 | Transmission of TPC commands |
| | for PUCCH and PUSCH |
| 2_3 | Transmission of a group of TPC |
| | commands for SRS transmissions |
| | by one or more UEs |
| 2_4 | Notifying a group of UEs of PRB(s) |
| | and OFDM symbol(s) where UE |
| | cancels the corresponding UL |
| | transmission from the UE |

DCI format 0_0 may be used to schedule a transport block (TB)-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH. In the case of a CSS, DCI format 0_0 and DCI format 1_0 have a fixed size after a BWP size is initially given by RRC. In the case of a USS, in DCI format 0_0 and DCI format 1_0, the sizes of fields except for the size of a frequency domain resource assignment (FDRA) field have a fixed size, whereas the size of the FDRA field may be changed through a related parameter configuration by the BS. In DCI format 0_1 and DCI format 1_1, the sizes of DCI fields may be changed through various RRC reconfigurations by the BS. DCI format 2_0 may be used to provide dynamic slot format information (e.g., SFI DCI) to the UE, DCI format 2_1 may be used to provide DL pre-emption information to the UE, and DCI format 2_4 may be used to indicate a UL resource on which the UE needs to drop UL transmission.

One of the representative scenarios of the next system, URLLC has the low-latency and high-reliability requirements of a user-plane delay of 0.5 ms and transmission of X bytes of data within lms at or below an error rate of 10-5. In general, eMBB is characterized by a large traffic capacity, a file size equal to or less than tens to hundreds of bytes, and sporadic occurrence. Therefore, eMBB requires transmission at a maximum transmission rate with minimum overhead of control information, whereas URLLC requires a short scheduling time unit and a reliable transmission method.

A reference time unit assumed/used to transmit/receive a physical channel may vary among application fields or types of traffic. The reference time may be a basic unit for scheduling a specific physical channel, and the reference time unit may depend on the number of symbols and/or subcarrier spacing, and the like constituting the corresponding scheduling time unit. For simplicity, some embodiments/implementations of the present disclosure are described based on a slot or mini-slot as a reference time unit. A slot may be, for example, a basic unit for scheduling used for general data traffic (e.g., eMBB). A mini-slot may have a smaller time period than a slot in the time domain, and may be a basic unit for scheduling used in a special purpose or in a special communication scheme (e.g., URLLC, or unlicensed band or millimeter wave, etc.). However, embodiment(s)/implementation(s) of the present disclosure may be applied even in transmitting/receiving a physical channel based on the mini-slot for the eMBB service or transmitting/receiving a physical channel based on the slot for URLLC or other communication techniques.

For a service having strict latency and reliability requirements (e.g., URLLC service), the reliability of PUSCH/PDSCH transmission may need to be higher than that of the existing PUSCH/PDSCH transmission. In order to improve the reliability of PUSCH/PDSCH transmission, repeated transmission of PUSCH/PDSCH may be considered.

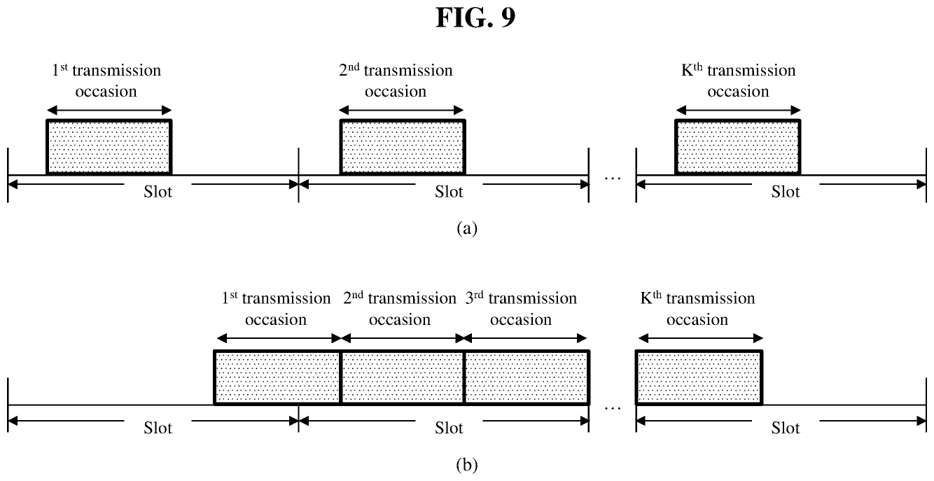

FIG. 9 illustrates types of repeated transmissions. Three types of repeated transmissions may be scheduled. In some implementations of the present disclosure, repetition of PUSCH/PDSCH may be applied to PUSCH/PDSCH transmission based on dynamic UL grant/DL assignment on PDCCH. The repetition of PUSCH/PDSCH may also be applied to transmission of PUSCH/PDSCH based on a configured grant. Repetitions to be applied to the PUSCH/PDSCH transmission may be indicated to or configured for the UE by the BS. For example, the UE may receive an indication of a repetition factor K through L1 signaling or a configuration thereof through higher layer signaling from the BS. Once the repetition factor K used to indicate the repetition number of the repeated transmission, or the like is indicated to or configured for the UE, the UE may repeat transmission/reception of a TB across K transmission/reception occasions. In the present disclosure, the repetition factor is also referred to as a repeated transmission factor.

The UE may be configured to perform multi-slot PUSCH transmission or multi-slot PDSCH reception. For example, referring to FIG. 9(a), the UE may be configured by the BS to apply the same symbol(s) allocation across K consecutive slots, where K is an integer greater than 1. In this case, the UE repeats transmission/reception of a TB across the K consecutive slots by applying the same slot(s) allocation in each of the K consecutive slots. In the present disclosure, an occasion on which a TB may be transmitted/received may be referred to as a transmission occasion/reception occasion. For example, when K PDSCH/PUSCH repetitions are indicated to the UE for the serving cell, the UE may perform PDSCH reception/PUSCH transmission in K consecutive DL slot(s)/subslot(s), starting in slot/subslot n. In this case, the UE may assume that all K PDSCH receptions/transmissions are performed in the same RB(s). In the present disclosure, the transmission occasion or the reception occasion is also referred to as a PUSCH (transmission) occasion in the case of a PUSCH and a PDSCH (transmission) occasion in the case of a PDSCH. Also, in the present disclosure, the transmission occasion is referred to as a transmission opportunity, and the reception occasion is referred to as a reception opportunity.

When the symbols of a slot allocated for PUSCH/PDSCH via a TDD UL-DL configuration by higher layer signaling and/or via SFI DCI are determined as downlink/uplink symbols, the UE omits transmission/reception in the slot for multi-slot PUSCH/PDSCH transmission/reception.

Hereinafter, PUSCH/PDSCH repetition performed by applying the same resource allocation across multiple consecutive slots is referred to as PUSCH/PDSCH repetition type A. In PUSCH/PDSCH repetition type A, when the UE receives resource allocation for wireless transmission from the BS, it may repeatedly use time-frequency resources defined in one slot on a slot-by-slot basis.

However, to cause the UE to perform PUSCH/PDSCH transmission/reception across multiple consecutive slots using the same resource allocation, the BS needs to secure the multiple consecutive slots. This may make flexible resource allocation difficult. In addition, when the BS intends to perform PDCCH transmission and PUSCH/PDSCH transmission in one slot, repetition of PUSCH/PDSCH for securing reliability may cause a large latency because only a few symbols of the latter half of the slot will be available as PUSCH/PDSCH transmission occasions. In the case of PUSCH/PDSCH transmission based on a configured grant, resource allocation for a TB may always be determined within one period of the configured grant. For example, a time duration for transmission of K repetitions for one TB may not exceed a time duration induced by the periodicity P of the configured grant. In some embodiments/implementations of the present disclosure, the UE may transmit/receive PUSCH/PDSCH according to a redundancy version (RV) sequence only at a predetermined position among a plurality of PUSCH/PDSCH resources for PUSCH/PDSCH repetition. For example, in some embodiments/implementations, when the configured RV sequence is {0, 2, 3, 1}, the UE starts the initial transmission of the TB on the first transmission occasion among K transmission occasions for K repetitions. In this case, a long time may need to be secured to secure the reliability of PUSCH/PDSCH transmission, or it may be difficult to configure a short periodicity using a plurality of PUSCH resources. In particular, when TB transmission is started in the middle of a plurality of PUSCH/PDSCH resources within a periodicity of the configured grant, that is, on an intermediate transmission occasion among the transmission occasions, it may be difficult to perform the repetition a sufficient number of times. Therefore, in the next radio access technology, it is being discussed to enable more flexible scheduling for URLLC by configuring resources regardless of slot boundaries or by repeatedly using resources on a symbol-by-symbol basis. For example, for more flexible and efficient resource utilization and service support and for faster and more robust UL/DL channel transmission, PUSCH/PDSCH may need to be repeated at an interval shorter than a slot, or resources for PUSCH/PDSCH repetition may need to be allocated regardless of the slot boundary, as illustrated in FIG. 9(b).

Referring to FIG. 9(b), the UE may be instructed or configured by the BS to perform PUSCH/PDSCH repetition back to back. Hereinafter, PUSCH/PDSCH repetition in which radio resources for PUSCH/PDSCH repetition are concatenated back to back in the time domain will be referred to as PUSCH/PDSCH repetition type B.

In some scenarios, it may be advantageous to periodically configure bursts of resources for repeated transmissions. For example, it may be advantageous that, for an SPS/CG configuration on an unlicensed band, once PDSCH/PUSCH transmissions are started for the UE, PDSCH/PUSCH occasions are assigned consecutively to prevent the UE from losing channel occupancy. In consideration of this, for example, to periodically allocate a burst of resources for CG-based PUSCHs, the BS may signal cg-nrofSlots providing the number of consecutive slots allocated within a configured CG grant period and cg-nrofPUSCH-InSlot providing the number of consecutive PUSCH allocations within a slot to the UE, a first PUSCH allocation among consecutive PUSCH allocations in a slot may follow the time domain allocation timeDomainAllocation for the CG grant, and the remaining PUSCH allocations may have the same length and PUSCH mapping type as the time domain allocation timeDomainAllocation and may be appended following previous assignments without a gap. The same combination of a start symbol, a length, and a PUSCH mapping type may repeat over the consecutively allocated slots.

In some implementations of the present disclosure, repetitions may be classified into nominal repetition and actual repetition. The nominal repetition may be determined based on resource allocation provided to the UE by a DCI (hereinafter referred to as scheduling DCI) or a SPS/CG configuration for scheduling PUSCH/PDSCH transmission. For example, for PUSCH repetition type B, for the n-th nominal repetition, n=0, . . . , numberOfRepetitions−1, i) a slot in which nominal repetition starts is given by Kₛ+floor{(S+n*L)/N^{slot}_{symb}} and a starting symbol relative to start of the slot is given by mod(S+n*L, N^{slot}_{symb}), ii) a slot in which nominal repetition ends is given by Kₛ+floor{(S+(n+1)*L−1)/N^{slot}_{symb}}, and an ending symbol relative to start of the symbol is given by mod(S+(n+1)*L−1, N^{slot}_{symb}). Here, numberOfRepetitions may be the number of repetitions indicated or configured by the BS, Ks may be a slot in which PUSCH transmission starts, N^{slot}_{symb} may be the number of symbols per slot, S and L may be given by time domain resource allocation (TDRA), S represents a start symbol relative to start of the slot, and L represents the number of consecutive symbols counted from the symbol S.

The actual repetition may be determined by applying the remaining elements(s) that is not considered to determine the nominal repetition. For example, a symbol indicated for downlink by RRC configuration tdd-UL-DL-ConfigurationCommon or tdd-UL-DL-ConfigurationDedicated may be regarded as an invalid symbol for PUSCH transmission, symbols indicated by ServingCellConfigCommon or ssb-PositionslnBurst in SIB1 for reception of SS/PBCH blocks may be considered as invalid symbols for PUSCH transmission, and symbol(s) indicated by pdcch-ConfigSIB1 in MIB for a CORESET for a TypeO-PDCCH CSS set as a CSS for reception of system information may be considered as invalid symbol(s) for PUSCH transmission. When the UE is configured with a higher layer (e.g. RRC) parameter invalidSymbolPattern providing a symbol-level bitmap spanning one or more slots, a bit value of 1 in the symbol-level bitmap may indicate that the corresponding symbol is an invalid symbol for a PUSCH transmission.

After determining invalid symbol(s) for nominal repetitions, the remaining symbols may be considered as potentially valid symbols for the corresponding PUSCH transmission. If the number of potentially valid symbols is greater than zero for a nominal repetition, the nominal repetition may include one or more actual repetitions, each actual repetition may include a set of potentially valid consecutive symbols to be used for PUSCH transmission within a slot. Referring to FIG. 9 (b), the nominal repetition of the first transmission occasion may be divided into two actual repetitions with a slot as a boundary. If the nominal repetition is divided into sets of potentially valid consecutive symbols by an invalid symbol, each of the sets of potentially valid consecutive symbols may be an actual repetition.

In the present disclosure, the nominal repetition of a PUSCH may be referred to as a nominal PUSCH, and the actual repetition of a PUSCH may be referred to as an actual PUSCH.

In some scenarios, repeated transmissions may be performed using a PUSCH/PDSCH/PUCCH at the same location between slots in a plurality of slots. In some scenarios, repeated transmissions may be performed using consecutive symbols irrespective of a slot boundary using PUSCH repetition type B. In some scenarios, several PUSCHs may be simultaneously scheduled for an unlicensed band, or consecutive PUSCHs at the same location may be allocated in a predetermined number of consecutive slots.

Since signaling for repeated transmissions of the various methods is different, it may be necessary to simplify signaling by integrating the repeated transmissions of the various methods and methods for allocating a plurality of resources in the next wireless communication system. In addition, according to a situation, there is a need for a more flexible setting method in which the UE and the BS dynamically select various repeated transmissions or use advantages of each repeated transmission.

In the present disclosure, implementations that indicate or configure various resource patterns for repeated transmission with only a small amount of information will be described. In addition, in the present disclosure, implementations from which unnecessary Listen Before Talk (LBP) and/or a channel access procedure (CAP) that may occur when using these various resource patterns are omitted will be described.

### In Terms of UE:

First, implementations according to the present disclosure will be described in terms of a UE.

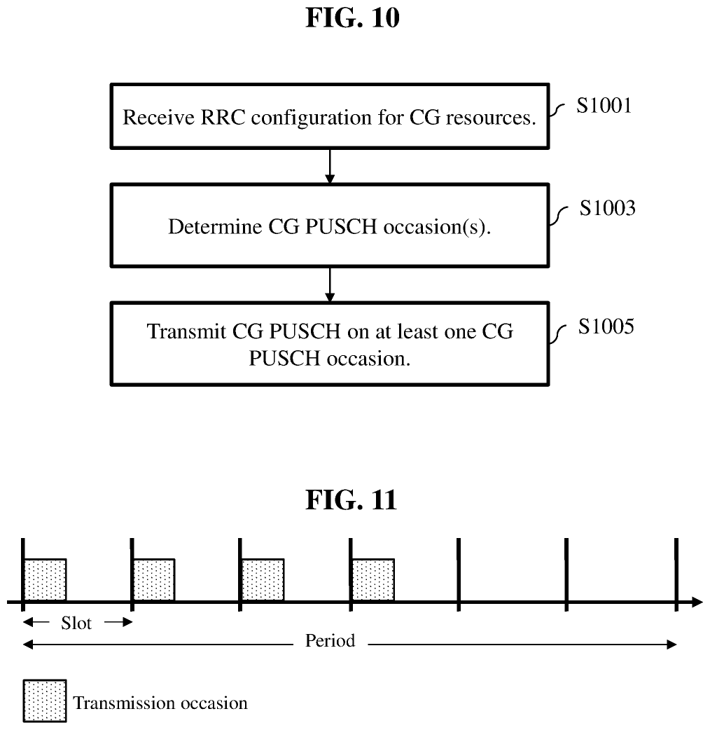

FIG. 10 shows an example of a channel transmission flow in a UE according to some implementations of the present disclosure.

When the UE performs uplink transmission based on a CG configuration received from the BS, CG resource(s) used for the uplink transmission may be determined according to some implementations of the present disclosure. For example, in some implementations of the present disclosure, the UE may operate as follows.

The UE may receive an RRC configuration for CG-based transmission from the BS (S1001). If necessary, the UE may receive activation DCI for a CG for CG-based transmission from the BS. Receiving the activation DCI may be omitted according to a CG configuration. For example, in the case of a Type 1 CG, receiving the activation DCI may be omitted. The UE may determine a temporal location(s) of the transmission opportunity(s) of the CG PUSCH based on the repeated transmission parameter(s) included in the RRC configuration for the CG (S1003). The UE may transmit the CG PUSCH at the determined CG PUSCH transmission opportunity (S1005).

In some implementations of the present disclosure, the following UE operation may be considered. For convenience of description in the present disclosure, the UE operation is mainly described based on uplink transmission using a configured grant, but implementations of the present disclosure are not limited thereto. For example, implementations of the present disclosure may also be applied to downlink SPS. When implementations of the present disclosure are applied to a downlink SPS, the BS may perform an SPS-based transmission operation and the UE may perform an SPS-based reception operation.

### Implementation A1 Unified Signaling for Repeated Resource Allocation

One or more of the following three values through L1 signaling from the BS (e.g., DCI through a PDCCH) or higher layer signaling (e.g., RRC signaling) to the UE for downlink or uplink repeated transmission configuration may be provided to the UE.
Value X: the number of resources transmitted/received in consecutive symbols. That is, the number of transmission/reception occasions repeated using a back-to-back method.
Value Y: The number of times the resources are repeated in units of slots. That is, the number of slots in which consecutive transmission/reception occasions are repeated.
Value Z: The number of resources used for one transport block (TB).

Through the value X, the UE may determine how many times resources of which a given start symbol is S and a length is L are repeated in consecutive symbols. For example, if the value X is x, it may be determined that the resources are repeated x times during L*x symbols.

Through the value Y, the UE may determine how many times slots spanned by a resource repeated X times during the L*X symbols are repeated. For example, when the value Y is y, it may be determined that x*y resources are set for ceil(S+L*x)*y slot(s).

Through the value Z, the UE may determine how many resources are be used for one TB among given X*Y resources. For example, when Z is a specific value (e.g., 0) or is not configured, all allocated resources may be determined to be available for one TB.

Implementation Al may be used for a repetition method of repeating a PUSCH/PDSCH/PUCCH at the same location between slots in a plurality of slots. For example, among the above values, X=1 and Y=Z=k may be set. In this case, k is a value of a repeated transmission factor.

For implementation of PUSCH repetition type B, for example, among the values, X=k, Y=1, and Z=0 may be configured. In this case, k is a value of a repeated transmission factor.

X, Y, and Z may be configured for arbitrary values for resource allocation of a configured grant on an unlicensed band. In this case, when a start symbol of a configured or indicated resource is S and a length thereof is L, S+L*X<14 needs to be satisfied to prevent given resource allocation from exceeding a slot boundary.

Implementation Al may also be applied to the case in which one entry of a TDRA table indicates a plurality of start and length indication values (SLIVs). In this case, parameters X, Y, and Z may also be applied to the respective SLIVs. For example, when {X=3, Y=1, Z=0}, one TDRA entry indicates two SLIVs, one of the two SLIVs is {S=0, L=7}, and another one is {S=7, L=7}), TB#1 may be repeated 3 times in 21 consecutive symbols starting from a symbol S=0, and TB#2 may be repeated 3 times in 21 consecutive symbols starting from a symbol S=7. In this case, since {S=7, L=7} does not overlap with {S=0, L=7} in a last slot among slots in which TB1 is repeated, TB#2 may be transmitted from the last slot among the slots in which TB1 is repeated. That is, each SLIV occupies two slots as described above, but two SLIVs may occupy three slots as a result.

FIGS. 11 to 14 show examples of resource allocations for repeated transmissions according to some implementations of the present disclosure. The repeated transmissions shown in FIGS. 11 to 14 may be indicated/configured to the UE according to implementation A1.

For the repeated transmissions shown in FIG. 11, the UE may be configured with {value X=1, value Y=4, value Z=4}.

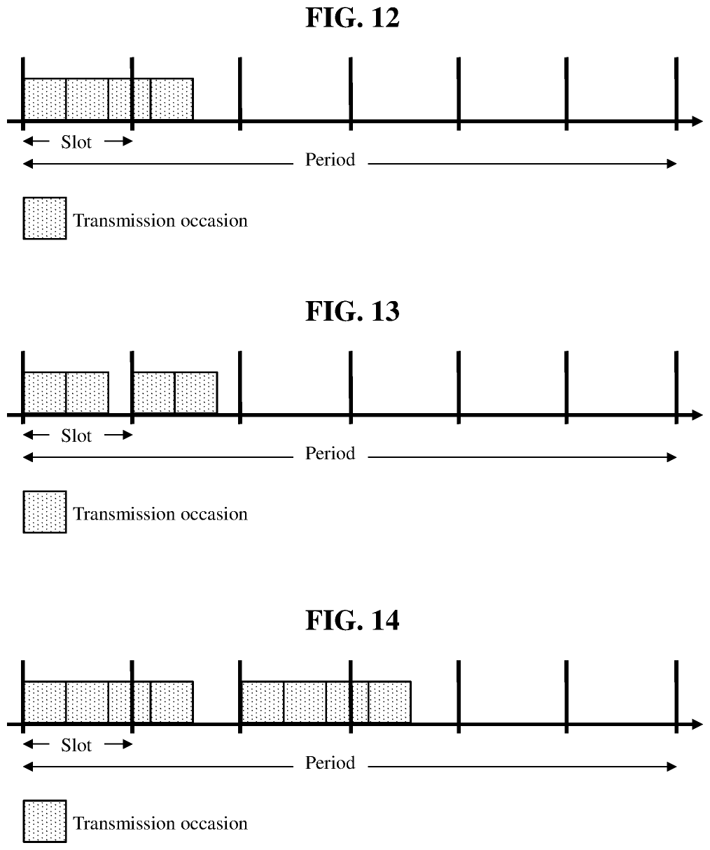

For repeated transmission similar to PUSCH repetition type B with repeat factor=4 shown in FIG. 12, the UE may be configured with {value X=4, value Y=1, value Z=4}.

When the UE is configured with {value X=2, value Y=2, value Z=2}, transmission occasions may be configured as shown in FIG. 13. Since value Z=2, any consecutive two transmission occasions in four transmission opportunities in the example of FIG. 13 may be used to repeat a single TB two times.

When the UE is configured with {value X=4, value Y=2, value Z=2}, transmission occasions may be configured as shown in FIG. 14, Since value Z=2, any consecutive two transmission occasions in 8 transmission opportunities in the example of FIG. 14 may be used to repeat a single TB two times.

### Implementation A2 Conditions to Omit Short PUSCH for LBT/CAP

In some scenarios, in the case of PUSCH repetition type B, actual repetitions may be determined from nominal repetitions in consideration of invalid symbol(s) and slot boundaries for transmission of PUSCH repetition type B for each of nominal repetitions. In some implementations, for PUSCH repetition type B, the actual repetition with a single symbol is omitted. This is to reduce unnecessary power consumption of the UE that may occur when only a DMRS RE is transmitted without a UL-SCH on a PUSCH. However, such PUSCH omission in an unlicensed band may result in giving up channel occupancy, and may cause the UE to perform LBT/CAP to newly occupy a channel at a next PUSCH occasion. Additional LBT/CAP trials may eventually lead to a decrease in overall reliability. Therefore, in Implementation A2, one symbol length PUSCH may not be unconditionally omitted, but may be omitted only under a predetermined condition or may not be omitted under a predetermined condition.

When resources are allocated using implementation Al or PUSCH repetition type B, if at least one of the following conditions is satisfied for a PUSCH of a predetermined length (e.g., one symbol) or less, the corresponding PUSCH may not be excluded from transmission.
The case in which a next symbol of a last symbol of the corresponding PUSCH is a start symbol of other PUSCH transmission. That is, the case in which an end of the corresponding PUSCH is start of other PUSCH transmission.
When all symbols of the corresponding PUSCH are configured as UL symbols through TDD-UL-DL-ConfigurationCommon, or TDD-UL-DL-configDedicated.
When a next symbol of a last symbol of the corresponding PUSCH is not configured as DL symbols through TDD-UL-DL-ConfigurationCommon, or TDD-UL-DL-configDedicated.
When the UE is configured to monitor DCI format 2_0, a next symbol of the last symbol of the corresponding PUSCH is a start symbol of another CG PUSCH transmission, and a symbol included in the other PUSCH transmission is configured as a UL symbol through TDD-UL-DL-ConfigurationCommon, or TDD-UL-DL-configDedicated.
When a next symbol of the last symbol of the corresponding PUSCH is a start symbol of another PUSCH transmission, and a symbol included in the other PUSCH transmission is not configured as a DL symbol through TDD-UL-DL-ConfigurationCommon, or TDD-UL-DL-configDedicated.
When a next symbol of the last symbol of the corresponding PUSCH is a start symbol of another CG PUSCH transmission, and a symbol included in the other PUSCH transmission is configured as a UL symbol or a flexible symbol through TDD-UL-DL-ConfigurationCommon, or TDD-UL-DL-configDedicated.
When the UE is configured to monitor DCI format 2_0, a next symbol of the last symbol of the corresponding PUSCH is a start symbol of another CG PUSCH transmission, and a symbol included in the other PUSCH transmission is configured as a UL symbol through TDD-UL-DL-ConfigurationCommon, or TDD-UL-DL-configDedicated.
The case in which a next symbol of the last symbol of the corresponding PUSCH is a start symbol of another UL transmission. That is, the case in which an end of the corresponding PUSCH is start of another UL transmission. The other UL transmission may be at least one of a PUCCH/SR/SRS.

In summary, in implementation A2, when resources are allocated using PUSCH repetition type B or implementation A1, transmission of a PUSCH of a predetermined length or less may be excluded according to a specific condition.

In implementation A2, a PUSCH may be excluded only in a specific condition, and thus a UE operation of excluding the PUSCH may be prevented from causing another LBT/CAP and the UE may occupy a channel more smoothly.

### Implementation A2-1

In implementation A2, other predetermined signals may be transmitted in a PUSCH A equal to or less than a predetermined length to which implementation A2 is applied instead. This is because when a small number of symbol lengths are used, a UL-SCH may not be transmitted in the corresponding symbol, and even when the UL-SCH is capable of being transmitted, it is difficult for such transmission to contribute to the overall reliability. In this case, it may be considered that a PUSCH A (where repeated transmission of a TB is omitted) is used according to at least one of the following.
In a PUSCH A, a DMRS RE may be transmitted without a UL-SCH. In this case, in order to allow the UE to transmit as many DMRS REs as possible, the BS may configure a DMRS port and/or a DMRS configuration to be applied when implementation A2 is used through L1 signaling or higher layer signaling. This may help channel estimation of other PUSCHs.
Another PUSCH may be transmitted by extending an adjacent front or rear PUSCH, that carries the same TB as a PUSCH A, in the same slot by a transmission length of the PUSCH A. That is, a symbol of the PUSCH A in which TB repetition is omitted may be used to extend a symbol length of another PUSCH for the TB.
If there is an adjacent rear PUSCH or other UL channel that carries the same TB as a PUSCH A, a cyclic prefix (CP) of the corresponding UL channel may be extended by a transmission length of the PUSCH A, and the corresponding UL channel may be transmitted from a time-frequency resource of the PUSCH A. That is, the CP of an adjacent rear UL channel may be transmitted in the time-frequency resource of the PUSCH A. This improves the channel robustness of the adjacent UL channel while reducing an implementation burden of the UE and allowing the UE to occupy a channel in consecutive symbols.

### In Terms of BS:

Some implementations according to the aforementioned specification will be described again in terms of a BS.

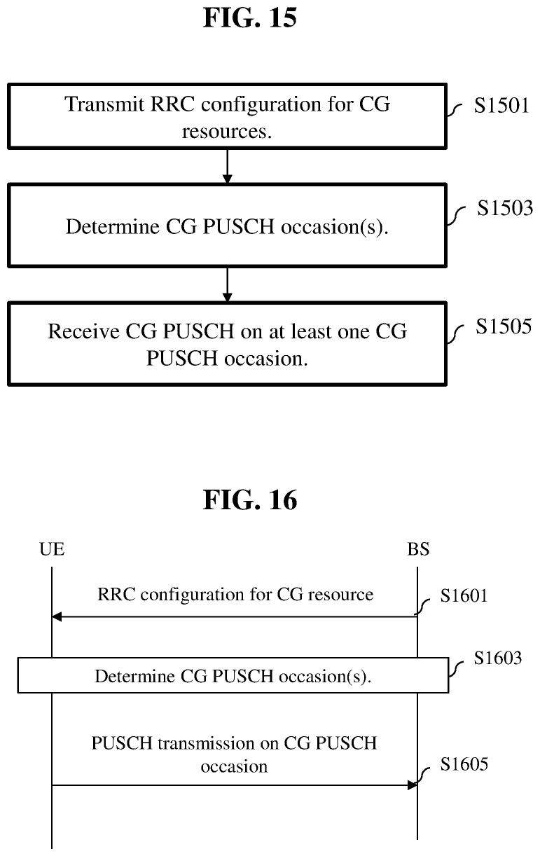

FIG. 15 shows an example of a channel reception flow in a BS according to some implementations of the present disclosure.

When the BS receives uplink transmission based on a CG configuration transmitted to the UE, CG resource(s) used in the uplink transmission may be determined according to some implementations of the present disclosure. For example, in some implementations of the present disclosure, the BS may operate as follows.

The BS may transmit an RRC configuration for CG-based UL transmission to the UE (S1501). The BS may transmit activation DCI for the CG for the CG-based UL transmission to the UE, if necessary. Transmission of the activation DCI may be omitted depending on the CG configuration. For example, in the case of Type 1 CG, transmission of the activation DCI may be omitted. The BS may determine temporal location(s) of the transmission opportunity(s) of the CG PUSCH based on repeated transmission parameter(s) included in the RRC configuration for the CG (S1503). The UE may receive the CG PUSCH at the determined CG PUSCH transmission opportunity (S1505).

In some implementations of the present disclosure, the following BS operation may be considered. For convenience of description in the present disclosure, the BS operation is mainly described based on uplink transmission using a configured grant, but implementations of the present disclosure are not limited. For example, implementations of the present disclosure may also be applied to downlink SPS. When implementations of the present disclosure are applied to a downlink SPS, the BS may perform an SPS-based reception operation and the UE may perform an SPS -based reception operation.

### Implementation B1 Unified Signaling for Repeated Resource Allocation

The BS may indicate or configure downlink or uplink repeated transmission to the UE to apply one or more of the following three values through L1 signaling (e.g., DCI through a PDCCH) or higher layer signaling (e.g., RRC signaling).
value X: the number of resources transmitted/received in consecutive symbols.
value Y: The number of times the resources are repeated in units of slots.
value Z: The number of resources used for one transport block (TB).

Through the value X, the BS and the UE may determine how many times resources of which a given start symbol is S and a length is L are repeated in consecutive symbols. For example, if the value X is x, it may be determined that the resources are repeated x times during L*x symbols.

Through the value Y, the UE may determine how many times slots spanned by a resource repeated X times during the L*X symbols are repeated. For example, when the value Y is y, it may be determined that x*y resources are set for ceil(S+L*x)*y slot(s).

Through the value Z, the BS and the UE may determine how many resources are be used for one TB among given X*Y resources. For example, when Z is a specific value (e.g., 0) or is not configured, all allocated resources may be determined to be available for one TB.

Implementation B1 may be used for a repetition method of repeating a PUSCH/PDSCH/PUCCH at the same location between slots in a plurality of slots. For example, among the above values, X=1 and Y=Z=k may be set. In this case, k is a value of a repeated transmission factor.

For implementation of PUSCH repetition type B, for example, among the values, X=k, Y=1, and Z=0 may be configured. In this case, k is a value of a repeated transmission factor.

X, Y, and Z may be configured for arbitrary values for resource allocation of a configured grant on an unlicensed band. In this case, when a start symbol of a configured or indicated resource is S and a length thereof is L, S+L*X<14 needs to be satisfied to prevent given resource allocation from exceeding a slot boundary.

Implementation B1 may also be applied to the case in which one entry of a TDRA table indicates a plurality of start and length indication values (SLIVs). In this case, parameters X, Y, and Z may also be applied to the respective SLIVs. For example, when {X=3, Y=1, Z=0}, one TDRA entry indicates two SLIVs, one of the two SLIVs is {S=0, L=7}, and another one is {S=7, L=7}), TB#1 may be repeated 3 times in 21 consecutive symbols starting from a symbol S=0, and TB#2 may be repeated 3 times in 21 consecutive symbols starting from a symbol S=7. In this case, since {S=7, L=7} does not overlap with {S=0, L=7} in a last slot among slots in which TB1 is repeated, TB#2 may be transmitted from the last slot among the slots in which TB1 is repeated. That is, each SLIV occupies two slots as described above, but two SLIVs may occupy three slots as a result.

### Implementation B2 Conditions to Omit Short PUSCH for LBT/CAP

In some scenarios, in the case of PUSCH repetition type B, actual repetitions may be determined from nominal repetitions in consideration of invalid symbol(s) and slot boundaries for transmission of PUSCH repetition type B for each of nominal repetitions. In some implementations, PUSCH repetition type B, the actual repetition with a single symbol is omitted. This is to reduce unnecessary power consumption of the UE that may occur when only a DMRS RE is transmitted without a UL-SCH on a PUSCH. However, such PUSCH omission in an unlicensed band may result in giving up channel occupancy, and may cause the UE to perform LBT/CAP to newly occupy a channel at a next PUSCH occasion. Additional LBT/CAP trials may eventually lead to a decrease in overall reliability. Therefore, in Implementation B2, one symbol length PUSCH may not be unconditionally omitted, but may be omitted only under a predetermined condition or may not be omitted under a predetermined condition.

When resources are allocated using implementation B1 or PUSCH repetition type B, if at least one of the following conditions is satisfied for a PUSCH of a predetermined length (e.g., one symbol) or less, it may be assumed that the corresponding PUSCH is not excluded from transmission.
The case in which a next symbol of a last symbol of the corresponding PUSCH is a start symbol of other PUSCH transmission. That is, the case in which an end of the corresponding PUSCH is start of other PUSCH transmission.
When all symbols of the corresponding PUSCH are configured as UL symbols through TDD-UL-DL-ConfigurationCommon, or TDD-UL-DL-configDedicated.
When a next symbol of a last symbol of the corresponding PUSCH is not configured as DL symbols through TDD-UL-DL-ConfigurationCommon, or TDD-UL-DL-configDedicated.
When the UE is configured to monitor DCI format 2_0, a next symbol of the last symbol of the corresponding PUSCH is a start symbol of another CG PUSCH transmission, and a symbol included in the other PUSCH transmission is configured as a UL symbol through TDD-UL-DL-ConfigurationCommon, or TDD-UL-DL-configDedicated.
When a next symbol of the last symbol of the corresponding PUSCH is a start symbol of another PUSCH transmission, and a symbol included in the other PUSCH transmission is not configured as a DL symbol through TDD-UL-DL-ConfigurationCommon, or TDD-UL-DL-configDedicated.
When a next symbol of the last symbol of the corresponding PUSCH is a start symbol of another CG PUSCH transmission, and a symbol included in the other PUSCH transmission is configured as a UL symbol or a flexible symbol through TDD-UL-DL-ConfigurationCommon, or TDD-UL-DL-configDedicated.
When the UE is configured to monitor DCI format 2_0, a next symbol of the last symbol of the corresponding PUSCH is a start symbol of another CG PUSCH transmission, and a symbol included in the other PUSCH transmission is configured as a UL symbol through TDD-UL-DL-ConfigurationCommon, or TDD-UL-DL-configDedicated.
The case in which a next symbol of the last symbol of the corresponding PUSCH is a start symbol of another UL transmission. That is, the case in which an end of the corresponding PUSCH is start of another UL transmission. The other UL transmission may be at least one of a PUCCH/SR/SRS.

In summary, in implementation B2, when resources are allocated using PUSCH repetition type B or implementation A1, transmission of a PUSCH of a predetermined length or less may be excluded according to a specific condition.

In implementation B2, a PUSCH may be excluded only in a specific condition, and thus a UE operation of excluding the PUSCH may be prevented from causing another LBT/CAP and the UE may occupy a channel more smoothly.

### Implementation B2-1

In implementation B2, other predetermined signals may be transmitted in a PUSCH A equal to or less than a predetermined length to which implementation B2 is applied instead. This is because when a small number of symbol lengths are used, a UL-SCH may not be transmitted in the corresponding symbol, and even when the UL-SCH is capable of being transmitted, it is difficult for such transmission to contribute to the overall reliability. In this case, it may be considered that a PUSCH A (where repeated transmission of a TB is omitted) is used according to at least one of the following.
In a PUSCH A, a DMRS RE may be transmitted without a UL-SCH. In this case, in order to allow the UE to transmit as many DMRS REs as possible, the BS may configure a DMRS port and/or a DMRS configuration to be applied when implementation B2 is used through L1 signaling or higher layer signaling. This may help channel estimation of other PUSCHs.
Another PUSCH may be transmitted by extending an adjacent front or rear PUSCH, that carries the same TB as a PUSCH A, in the same slot by a transmission length of the PUSCH A. That is, a symbol of the PUSCH A in which TB repetition is omitted may be used to extend a symbol length of another PUSCH for the TB.
If there is an adjacent rear PUSCH or other UL channel that carries the same TB as a PUSCH A, the UE may extend a cyclic prefix (CP) of the corresponding UL channel by a transmission length of the PUSCH A and may transmit the corresponding UL channel from a time-frequency resource of the PUSCH A. That is, the UE may transmit the CP of an adjacent rear UL channel in the time-frequency resource of the PUSCH A. This improves the channel robustness of the adjacent UL channel while reducing an implementation burden of the UE and allowing the UE to occupy a channel in consecutive symbols.

FIG. 16 shows an example of signal transmission/reception between a UE and a BS according to some implementations of the present disclosure.

Referring to FIG. 16, the BS may provide an RRC configuration for a CG resource to the UE (S1601). If necessary, the BS may transmit a UL grant through a PDCCH in order to activate the CG resource. The UE may receive the CG configuration provided by the BS, and in the case of a CG resource that requires activation DCI, the UE may perform monitoring for reception of the activation DCI for the CG resource. Based on the CG configuration (activated by the activation DCI or the RRC configuration), the BS and the UE may determine CG resource(s) used in uplink transmission based on repeated transmission parameter(s) according to some implementations of the present disclosure.

According to some implementations of the present disclosure, various resource patterns for repeated transmission may be indicated or configured using several parameters. Also, some of the parameters may be dynamically indicated. When some of the above parameters are dynamically indicated, the UE may be dynamically instructed with various resource patterns, and the BS may configure resources suitable for a service used by the UE. In addition, the overall reliability of PUSCH transmission by the UE may be improved by preventing unnecessary LBP/CAP that may occur when various resource patterns are used.

For transmission of a uplink channel, the UE may perform operations according to some implementations of the present disclosure. The UE may include: at least one transceiver; at least one processor; and at least one computer memory operably connected to the at least one processor and configured to store instructions that, when executed, cause the at least one processor to perform the operations according to some implementations of the present disclosure. A processing device for the UE may include: at least one processor; and at least one computer memory operably connected to the at least one processor and configured to store instructions that, when executed, cause the at least one processor to perform the operations according to some implementations of the present disclosure. A computer-readable (non-volatile) storage medium may store at least one computer program including instructions that, when executed by at least one processor, cause the at least one processor to perform the operations according to some implementations of the present disclosure. A computer program or computer program product may include instructions that are stored on at least one computer-readable (non-volatile) storage medium and, when executed, cause (at least one processor) to perform the operations according to some implementations of the present disclosure.

In the UE, the processing device, the computer readable (non-volatile) storage medium, and/or the computer program product, the operations may include: receiving resource allocation; determining a plurality of PUSCH occasions based on the resource allocation; and for a PUSCH occasion having a time length equal to or less than a predetermined length among the plurality of PUSCH occasions, performing PUSCH transmission if a predetermined condition is satisfied, and omitting the PUSCH transmission if the predetermined condition is not satisfied.

For reception of a uplink channel, the BS may perform operations according to some implementations of the present disclosure. The BS may include: at least one transceiver; at least one processor; and at least one computer memory operably connected to the at least one processor and configured to store instructions that, when executed, cause the at least one processor to perform the operations according to some implementations of the present disclosure. A processing device for the BS may include: at least one processor; and at least one computer memory operably connected to the at least one processor and configured to store instructions that, when executed, cause the at least one processor to perform the operations according to some implementations of the present disclosure. A computer-readable (non-volatile) storage medium may store at least one computer program including instructions that, when executed by at least one processor, cause the at least one processor to perform the operations according to some implementations of the present disclosure. A computer program or computer program product may include instructions that are stored on at least one computer-readable (non-volatile) storage medium and, when executed, cause (at least one processor) to perform the operations according to some implementations of the present disclosure.

In the BS, the processing device, the computer-readable (non-volatile) storage medium, and/or the computer program product, the operations include: transmitting resource allocation to the UE; determining a plurality of PUSCH occasions based on the resource allocation; for a PUSCH occasion having a time length equal to or less than a predetermined length among the plurality of PUSCH occasions, performing PUSCH reception if a predetermined condition is satisfied, and omitting the PUSCH reception if the predetermined condition is not satisfied.

In some implementations of the present disclosure, the predetermined condition may include the following: an immediately next symbol of the last symbol of the PUSCH occasion of which a time length is equal to or less than the predetermined length is a start symbol of another PUSCH occasion.

In some implementations of the present disclosure, the predetermined condition may include the following: an immediately next symbol of the last symbol of the PUSCH occasion for which a time length is equal to or less than the predetermined length is configured as an uplink symbol through a wireless source control configuration for a time division duplex (TDD) uplink-downlink configuration.

In some implementations of the present disclosure, resource allocation may include i) the number of resources repeated in consecutive symbols, ii) the number of slots in which consecutive resources are repeated, and iii) the number of resources used for one transport block.

In some implementations of the present disclosure, the PUSCH occasion may be a transmission occasion of actual repetition.

The examples of the present disclosure as described above have been presented to enable any person of ordinary skill in the art to implement and practice the present disclosure. Although the present disclosure has been described with reference to the examples, those skilled in the art may make various modifications and variations in the example of the present disclosure. Thus, the present disclosure is not intended to be limited to the examples set for the herein, but is to be accorded the broadest scope consistent with the principles and features disclosed herein.

### INDUSTRIAL APPLICABILITY

The implementations of the present disclosure may be used in a BS, a UE, or other equipment in a wireless communication system.

1. A method of transmitting a physical uplink shared channel (PUSCH) by a user equipment (UE) in a wireless communication system, the method comprising:
receiving resource allocation;
determining a plurality of PUSCH occasions based on the resource allocation; and
for a PUSCH occasion having a time length equal to or less than a predetermined length among the plurality of PUSCH occasions, performing PUSCH transmission if a predetermined condition is satisfied, and omitting the PUSCH transmission if the predetermined condition is not satisfied.

2. The method of claim 1, wherein the predetermined condition includes a following condition:
an immediately next symbol of a last symbol of the PUSCH occasion for which a time length is equal to or less than the predetermined length is a start symbol of another PUSCH occasion.

3. The method of claim 1, wherein the predetermined condition includes a following condition:
an immediately next symbol of a last symbol of the PUSCH occasion for which a time length is equal to or less than the predetermined length is configured as an uplink symbol through a radio resource control configuration for a time division duplex (TDD) uplink-downlink configuration.

4. The method of claim 1, wherein the resource allocation includes i) a number of resources repeated in consecutive symbols, ii) a number of slots in which consecutive resources are repeated, and iii) a number of resources used for one transport block.

5. A user equipment for transmitting a physical uplink shared channel (PUSCH) in a wireless communication system, comprising:
at least one transceiver;
at least one processor; and
at least one computer memory operatively connected to the at least one processor and configured to store instructions that when executed causes the at least one processor to perform operations including:
receiving resource allocation;
determining a plurality of PUSCH occasions based on the resource allocation; and
for a PUSCH occasion having a time length equal to or less than a predetermined length among the plurality of PUSCH occasions, performing PUSCH transmission if a predetermined condition is satisfied, and omitting the PUSCH transmission if the predetermined condition is not satisfied.

6-9. (canceled)

10. A base station (BS) for receiving a physical uplink shared channel (PUSCH) from a user equipment (UE) in a wireless communication system, comprising:
at least one transceiver;
at least one processor; and
at least one computer memory operatively connected to the at least one processor and configured to store instructions that when executed causes the at least one processor to perform operations including:
transmitting resource allocation to the UE;
determining a plurality of physical uplink shared channel (PUSCH) occasions based on the resource allocation; and
for a PUSCH occasion having a time length equal to or less than a predetermined length among the plurality of PUSCH occasions, performing PUSCH reception if a predetermined condition is satisfied, and omitting the PUSCH reception if the predetermined condition is not satisfied.
